(19) United States
(12) Patent Application Publication
(10) Pub. No.: US 2026/0097506 A1
(43) Pub. Date: Apr. 9, 2026

(54) GENERATING TEST ENVIRONMENTS TO OPTIMIZE PERFORMANCE OF ROBOTS

(71) Applicant: Field AI, Inc., Mission Viejo, CA (US)

(72) Inventors: Shayegan OMIDSHAFIEI, Dorchester, MA (US); Dong Ki KIM, Cambridge, MA (US); Aliakbar AGHAMOHAMMADI, Mission Viejo, CA (US); David Fan, Lake Forest, CA (US)

(73) Assignee: Field AI, Inc., Mission Viejo, CA (US)

(21) Appl. No.: 19/351,428

(22) Filed: Oct. 7, 2025

Related U.S. Application Data
(60) Provisional application No. 63/704,643, filed on Oct. 8, 2024.
(60) Provisional application No. 63/704,129, filed on Oct. 7, 2024.

(51) Int. Cl. B25J 9/16

(52) U.S. Cl. CPC B25J 9/1671

(57) ABSTRACT

Systems and methods for generating virtual test environments (VTEs) to optimize performance of robots are provided. A system may generate, at a simulation platform via a language model, a VTE configured for testing performance of a robotics foundational model (RFM) during a virtual mission. The system may test the performance of the RFM in the VTE including: (a) causing the RFM to perform the virtual mission; (b) obtaining virtual operational data associated with the performance of the RFM during the virtual mission; and (c) analyzing the virtual operational data to determine virtual operational characteristic for further testing. Based upon determining virtual operational characteristic for further testing, the system may provide the virtual operational data to the language model as an input causing the language model to reconfigure the VTE for further testing the virtual operational characteristic, and repeat steps (a)-(c).

### CROSS-REFERENCE TO RELATED APPLICATION

This application claims priority to and the benefit of the filing dates of provisional U.S. Patent Application No. 63/704,129, entitled “SYSTEM AND METHOD FOR GENERATING DYNAMIC TEST ENVIRONMENTS TO OPTIMIZE PERFORMANCE OF ROBOTS” and filed on October 7, 2024, and provisional U.S. Patent Application No. 63/704,643, entitled “SYSTEM AND METHOD FOR ADVERSARIAL TESTING OF ROBOT FLEETS USING TEST ENVIRONMENTS” and filed on October 8, 2024, the entire contents of each of which is hereby expressly incorporated herein by reference.

### TECHNICAL FIELD

The implementations of the present disclosure relate to robotic systems, and specifically to systems and methods for generating virtual test environments to optimize performance of robots.

### BACKGROUND

Robotics foundation models have emerged as a promising approach for developing versatile and adaptable robotic systems capable of performing a wide range of tasks. The robotics foundation models may be based on large-scale machine learning architectures and aim to provide a general-purpose foundation for robotic perception, reasoning, and action. Nevertheless, the development and refinement of the robotics foundation models present significant challenges, particularly in ensuring their reliability, robustness, and safety across diverse and complex environments. Moreover, the robotics foundational models leverage large-scale pre-training on diverse datasets to learn general-purpose representations and skills that may be fine-tuned for specific applications. However, as the robotics systems implementing robotics foundation models become more autonomous and are deployed in real-world environments, ensuring safety, reliability, and robustness of the robotics systems become increasingly critical.

Traditionally, testing and/or validation of the robotic systems has generally relied on the manual creation of test scenarios and environments, for example implementing predefined test cases and controlled environments. Manually designed test cases may inadvertently introduce biases or overlook critical edge cases that may lead to failures in practical applications. This approach, while valuable, is limited in scope and fails to capture full range of potential situations robots may encounter in real-world deployments, potentially leading to failures and unsafe behavior when a fleet of robots is deployed in dynamic and unstructured environments.

Some existing approaches have attempted to address these limitations through the use of procedural generation techniques to create varied test environments. While the existing approaches may improve generalization to real-world scenarios, the existing approaches lack the ability to systematically target specific weaknesses in the robots. Existing testing frameworks for robots further lack the ability to automatically adapt and evolve test scenarios as the performance of the robots improves. This limitation can lead to a false sense of security, as existing regression techniques may become less effective over time upon identifying new weaknesses or regressions in performance of the robots. Additionally, current approaches may struggle to adapt and evolve testing strategies in response to the dynamic nature of robotic behaviors and environments. The challenges in testing and validating the robotics foundation models are further compounded by the rapid pace of development in the field. As the robotics foundation models become more sophisticated and are applied to increasingly diverse tasks and environments, there is a growing need for automated, scalable, and adaptive testing methodologies that may keep pace with these advancements.

Adversarial testing has been proposed as a method to identify weaknesses in the robotic systems by deliberately attempting to cause failures or unexpected behaviors. However, existing adversarial testing approaches for the robotic systems focus on isolated components and/or simulated environments, limiting ability of the robot fleets to uncover vulnerabilities that may only emerge in real-world, system-level interactions. Red teaming, a practice borrowed from cybersecurity, involves simulating attacks or challenges to identify the weaknesses in robot fleets. While the red teaming has been applied to various domains, application of the red teaming to the robotics foundation models has been limited, particularly in real-time, real-world settings. Language models, such as large language models, have demonstrated remarkable capabilities in natural language processing and reasoning tasks. However, the potential of language models for managing and coordinating complex testing scenarios for the robotic systems via procedural generation techniques remains largely unexplored.

In sum, existing procedural generation testing techniques lack the flexibility and creativity to systematically target robotic weaknesses, progressively increase complexity, effectively evaluate the robustness and safety of robot fleets in real-world conditions, and provide insights for continuous improving and refining robots. In light of these technical limitations and challenges, there exists a clear need for a technical solution to testing (e.g., via regression testing and red-teaming) robotics foundation models and associated physical robots.

### SUMMARY

In one general aspect, the instant disclosure describes a system for generating virtual test environments to optimize performance of robots. The system may include one or more processors; and one or more memories having stored thereon processor-executable instructions that, when executed by the one or more processors, cause the one or more processors to perform operations of: generating, at a simulation platform via a language model, a virtual test environment configured for testing performance of a robotics foundational model (RFM) during a virtual mission in the virtual test environment, wherein: the virtual test environment simulates a physical environment; and the RFM corresponds to a physical robot, and is configured to perform a virtual mission in the virtual test environment; testing the performance of the RFM during the virtual mission in the virtual test environment including: (a) causing the RFM to perform the virtual mission in the virtual test environment; (b) obtaining virtual operational data associated with the performance of the virtual mission, the virtual operational data indicating one or more virtual operational characteristics of the RFM during the virtual mission, wherein the one or more virtual operational characteristics of the RFM correspond to one or more respective operational characteristics of the physical robot; and (c) analyzing the virtual operational data to determine whether the virtual operational data indicates a virtual operational characteristic for further testing of the one or more virtual operational characteristics; and based upon determining the virtual operational data indicates the virtual operational characteristic for further testing, providing the virtual operational data to the language model as an input causing the language model to reconfigure, at the simulation platform, the virtual test environment for testing the virtual operational characteristic of the RFM for further testing indicated in the virtual operational data, and repeating steps (a)-(c).

In another general aspect, the instant disclosure describes a computer-implemented method for generating virtual test environments to optimize performance of robots. The computer-implemented method may include generating, by one or more processors, at a simulation platform via a language model, a virtual test environment configured for testing performance of a robotics foundational model (RFM) during a virtual mission in the virtual test environment, wherein: the virtual test environment simulates a physical environment; and the RFM corresponds to a physical robot, and is configured to perform a virtual mission in the virtual test environment; testing, via the one or more processors, the performance of the RFM during the virtual mission in the virtual test environment including: (a) causing the RFM to perform the virtual mission in the virtual test environment; (b) obtaining virtual operational data associated with the performance of the virtual mission, the virtual operational data indicating one or more virtual operational characteristics of the RFM during the virtual mission, wherein the one or more virtual operational characteristics of the RFM correspond to one or more respective operational characteristics of the physical robot; and (c) analyzing the virtual operational data to determine whether the virtual operational data indicates a virtual operational characteristic for further testing of the one or more virtual operational characteristics; and based upon analyzing the virtual operational data, performing, by the one or more processors, a testing action associated with providing the virtual operational data to the language model and repeating steps (a)-(c).

In another general aspect, the instant disclosure describes a non-transitory computer-readable medium storing processor-executable instructions that, when executed by one or more processors, may cause the one or more processors to at least: generate, at a simulation platform via a language model, a virtual test environment configured for testing performance of a robotics foundational model (RFM) during a virtual mission in the virtual test environment, wherein: the virtual test environment simulates a physical environment; and the RFM corresponds to a physical robot, and is configured to perform a virtual mission in the virtual test environment; test the performance of the RFM during the virtual mission in the virtual test environment including: (a) cause the RFM to perform the virtual mission in the virtual test environment; (b) obtain virtual operational data associated with the performance of the virtual mission, the virtual operational data indicating one or more virtual operational characteristics of the RFM during the virtual mission, wherein the one or more virtual operational characteristics of the RFM correspond to one or more respective operational characteristics of the physical robot; and (c) analyze the virtual operational data to determine whether the virtual operational data indicates a virtual operational characteristic for further testing of the one or more virtual operational characteristics; and based upon determining the virtual operational data indicates the virtual operational characteristic for further testing, provide the virtual operational data to the language model as an input causing the language model to reconfigure, at the simulation platform, the virtual test environment for testing the virtual operational characteristic of the RFM for further testing indicated in the virtual operational data, and repeating steps (a)-(c).

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a block diagram of an example workflow for generating virtual test environments to optimize performance of robots, in one implementation of the instant application.

FIG. 2 depicts an example virtual test environment, in one implementation of the instant application.

FIG. 3 depicts example information associated with a performance analysis of a robot foundational model during a virtual mission, in one implementation of the instant application.

FIG. 4 is a block diagram of an example workflow for generating physical test environments to optimize performance of robots, in one implementation of the instant application.

FIG. 5 depicts an example physical test environment for testing multiple physical robots, in one implementation of the instant application.

FIG. 6 is a flow diagram of an example computer-implemented method for generating virtual test environments to optimize performance of robots, in one implementation of the instant application.

FIG. 7 is a block diagram of an example computing environment for generating virtual test environments to optimize performance of robots, in one implementation of the instant application.

FIG. 8 is a block diagram of example subsystems of the computing environment of FIG. 7, in one implementation of the instant application.

FIG. 9 is a block diagram of an example robotics foundation model of the computing environment of FIG. 7, in one implementation of the instant application.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well-known methods, procedures, components, and/or circuitry have been described at a relatively high-level, without detail, in order to avoid unnecessarily obscuring aspects of the present teachings.

Conventional systems and methods for testing robots suffer from several technical problems. Such robot testing generally includes the manual creation of test scenarios and environments (e.g., predefined test cases and/or controlled environments) that can introduce biases, overlook critical edge cases, and/or generally fail to capture a range of potential situations robots may encounter in real-world deployments, leading to failures and unsafe behavior by a robot (e.g., when placed in dynamic and unstructured environments). Further, existing testing approaches can lack the ability to systematically target specific weaknesses in the robots, automatically adapt and evolve test scenarios as the performance of the robots improves (e.g., based upon improvements in robotics foundation models), and/or evolve testing strategies in response to the dynamic nature of robotic behaviors and/or environments. Moreover, vulnerabilities that emerge in real-world scenarios (e.g., system-level interactions) may go undetected when only implementing simulation-based testing of robots. Even further still, the implementation of red teaming and language models for providing complex testing scenarios remains underutilized. The disclosed systems and methods provide technical solutions to such technical problems by implementing sophisticated analyses of the performance of robots in both simulated and real-world testing environments. A language model may generative data used to reconFIGURE(e.g., iteratively) the test environment to further test operational characteristics identified by the performance analysis. This can include test environments that perform red teaming to create adversarial conditions for the robot under test. The discloses systems and methods provide a testing framework that provides at least these advantages, improvements, and/or otherwise technical solutions to the aforementioned technical problems.

The disclosed systems and methods generate test environments (e.g., virtual test environment and non-virtual/physical test environments) to optimize performance of robots, including robotics foundational models (RFMs) and physical robots. An example system may implement a language model (e.g., a large language model) to generate a virtual test environment at a simulation platform. The virtual test environment may be configured for testing performance of the RFM during a virtual mission in the virtual test environment. The virtual test environment may simulate a physical environment. The RFM may correspond to a physical robot, such that the RFM is configured with the same and/or similar capabilities in the virtual test environment as the capabilities of the physical robot. Accordingly, the performance of the RFM during the virtual mission in the virtual test environment may simulate the performance of a physical robot performing a mission in the physical test environment.

Testing the performance of the RFM during the virtual mission in the virtual test environment may include multiple steps. One step may include causing the RFM to perform the virtual mission in the virtual test environment. A second step may include obtaining virtual operational data associated with the performance of the virtual mission. The virtual operational data may indicate virtual operational characteristics of the RFM during the virtual mission that corresponds to operational characteristics of the physical robot. A third step may include analyzing (e.g., using the language model) the virtual operational data to determine whether the virtual operational data indicates a virtual operational characteristic for further testing.

If the system determines the virtual operational data indicates a virtual operational characteristic for further testing, the system may input the virtual operational data to the language model causing the language model to reconfigure the virtual test environment at the simulation platform for further testing of the indicated virtual operational characteristic. The system may further repeat the three steps for testing the performance of the RFM. If the system determines the virtual operational data does not indicate the virtual operational characteristic for further testing, the system may refrain from providing the virtual operational data to the language model as well as refrain from repeating the three steps for testing the RFM performance.

In at least some implementations, the system may cause a physical robot corresponding to the RFM to perform a mission in a physical test environment corresponding to the virtual test environment. The system may obtain and analyze operational data generated by the physical robot during the mission to determine whether the operational data indicates an operational characteristics for further testing. Based upon identifying an operational characteristic for further testing, the system may generate and reconFIGURE(e.g., via the language model) the physical robot with robot configuration to improve the operational characteristic of the physical robot. The improved operational characters may be identified as requiring further testing in a reconfigured physical and/or virtual test environment.

The disclosed systems and methods address the aforementioned shortcomings of conventional systems and methods for testing robots via testing environments. The performance analysis of the robot during the mission in conjunction with reconfiguring the test environment to address further testing identified operational characteristics according to the disclosed techniques allows the instant testing framework to compensate for and/or otherwise address innate biases and/or performance in critical edge case environments that are not provided by conventional testing systems. The disclosed techniques explore the implementation of red teaming and/or language modelling capabilities, such as natural language processing and reasoning, for testing robots that conventional robotic testing systems cannot provide, for example by (re)configuring complex testing scenarios, evaluating robotic performance of a mission, and/or reconfiguring a robot. In sum, the disclosed system and methods provide improvements to conventional robotic testing systems, and more generally advancements in the field of robotics testing, by generating test environments that optimize performance of robots, as just described.

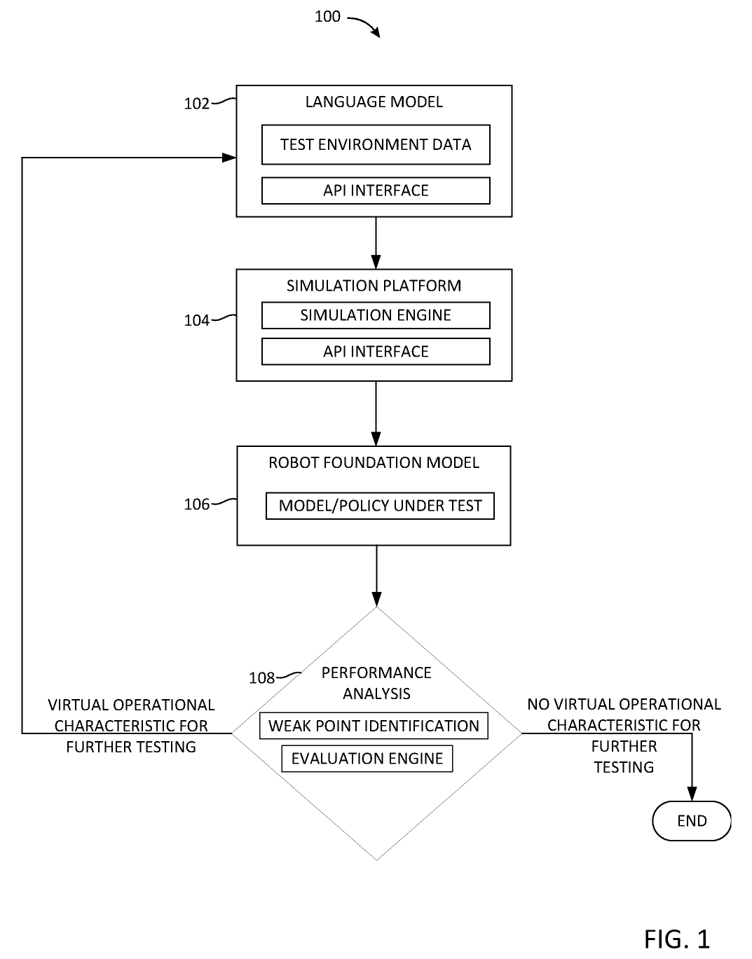

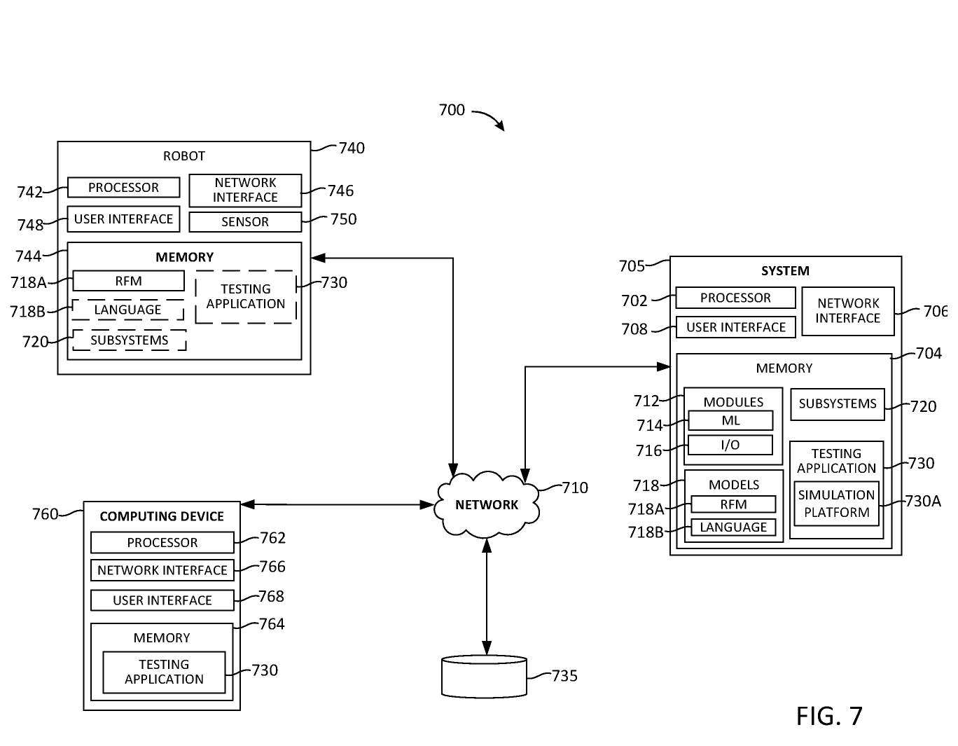

FIG. 1 is a block diagram of an example workflow 100 for generating virtual test environments to optimize performance of robots, in one implementation of the instant application. The workflow 100 may include implementation of a language model 102. The language model 102 may be trained, stored, and/or implemented by one or more computing or otherwise electronic devices (e.g., a server, a desktop computer, a mobile computing device, a robot etc.) and/or components (e.g., a processors, a memory, a database) as further described herein, such as devices and components of a computing environment 700 of FIG. 7. The language model 102 may be a large language model (LLM), medium language model, small language model, hybrid langue model, a pre-trained language model, a fine-tuned language model, a foundational language model, and/or any other suitable language model. The language model 102 may be configured (e.g., trained) to perform functions associated with generating a test environment for testing a robot, such as a robotics foundation model (RFM) and/or a physical robot. The test environment may be configured to simulate an atypical physical environment (e.g., an edge case including an environment not usually encountered by the robot), test the performance (e.g., sub-par performance, improvements in performance, new and/or different performance capabilities) of the robot, test a policy under test of the robot, test collaboration of multiple robots, and/or any other suitable configuration of the test environment for testing the robot.

In at least some implementations, the language model 102 and/or other suitable device and/or component (e.g., a computing device implementing the language model 102) may be configured to determine the characteristics of the test environment based upon a mission of the robot in the test environment (e.g., a mission to test performance of the robot), one or more operational characteristics of the robot (e.g., indicative of the performance of the robot in the test environment), and/or any other suitable criteria. The language model 102 may generate test environment data (e.g., code, instructions, text, descriptions, images, video, etc.) associated with the test environment, such as test environment data indicating the characteristics of the test environment. For example, the test environment data may indicate (e.g., textually describe, visually depict) characteristics of the test environment, such as the type of environment (e.g., a commercial building, a house, an outdoor environment, etc.), the dimensions of the environment, the composition of the environment (e.g., the type of surfaces, number and size of rooms, objects in the environment such as obstacles), and/or any other suitable characteristics of the test environment. The test environment data generated by the language model 102 may be used to configure the physical test environment and/or the virtual test environment.

The virtual test environment may be generated by the language model 102 at a simulation platform 104 using the test environment data. The simulation platform 104, such as NVIDIA Isaac®, may be, and/or include, a simulation engine (e.g., physics engine, gaming engine), such as an Unreal®, PhysX®, Unity®, Gamebryo®, Vision®, Instinct®, Panda3D®, Diesel®, Torque®, HeroEngine®, BigWorld®, and/or any other suitable simulator and/or engine. In some such implementations, the language model 102 may communicate (e.g., via a network, a system bus) with the simulation platform 104 via an application programing interface (API). For example, the language model 102 may generate API data (e.g., code configured for making one or more API calls to the simulation platform 104) associated with configuring the virtual test environment with virtual characteristics at the simulation platform 104. The language model 102 may transmit API data to the simulation platform 104 to generate and/or otherwise configure the virtual test environment at the simulation platform 104.

In at least some implementations, the language model 102 may include a plurality of language models, such as a plurality of fine-tuned language models, which each language model configured to generate one or more virtual characteristics of the virtual test environment. For example, a first language model may be configured to generate an API dataset associated with configuring rendering parameters such as lighting characteristics of the virtual test environment, a second language model may be configured to generate an API dataset associated with configuring physics parameters of the virtual test environment, and a third language model may be configured to generate API dataset associated with configuring object attributes of virtual obstacles of the virtual test environment, etc. Based upon the virtual characteristics of the virtual test environment or be configured, the language model 102 and/or other suitable device and/or component may identify one or more language models (e.g., fine-tuned language models) to configure each of the virtual characteristics of the virtual test environment, and cause each of the identified language models to generate an API dataset of the API data for configuring the respective virtual characteristics of the virtual test environment.

In response to receiving the API data from the language model 102 via the API interface, the simulation platform 104 may generate the virtual test environment configured with the characteristics indicated in the API data. The simulation platform 104 may be configured to simulate a virtual test environment having characteristics such as object attributes (e.g., translation, rotation, and/or scale; visibility; material and/or textures), physics parameters (e.g., collision shape, friction, restitution, and/or damping; physics scene settings such as a gravity vector, solver iterations, substeps, contact offset, and/or rest offset), robot parameters (e.g., initial positions, initial rotations, payload weight, center of mass, sensor noise models, sensor positions, sensor rotations), rendering parameters (e.g., lighting intensity, color, temperature, shadows, attenuation; material base color, roughness, metallic) simulation parameters (e.g., Sim dt such as timestep), and/or any other suitable characteristics of the virtual test environment. The API data may indicate the virtual test environment characteristics, for example characteristics of the virtual test environment such as lighting intensity, flooring surface roughness, and/or the number, location and/or size of obstacles of the virtual test environment.

The workflow 100 may include executing an RFM 106 to perform a virtual mission in the virtual test environment. The RFM 106 may be based on one or more large-scale ML architectures. The RFM 106 may aim to provide a general-purpose foundation for robotic perception, reasoning, and action. In the physical world, the functionality of a physical robot may be implemented, controlled, and/or otherwise provided by the RFM 106. For example, the physical robot may include a memory storing the RFM 106. Once executed (e.g., via a processor of the physical robot), the RFM 106 may receive data (e.g., sensor data from sensors of the physical robot, mission instructions received via an API) as an input, and in response generate commands (e.g., code, instructions) as an output. The commands may be associated with implementing functionality of the physical robot. In one example, in response to receiving sensor data from an imaging sensor of the physical robot, the RFM 106 may output commands that are associated with generating a map of the physical environment. Such commands may be provided to a mapping subsystem of the physical robot causing the mapping system to generate a map of the physical environment. Thus, the RFM 106 may be associated with providing functionality of the physical robot associated with generating maps of the physical environment. In another example, the RFM 106 may receive mission instructions indicating the physical robot should find the safest navigation path from a mission start location to a mission end location of the physical environment. In response, the RFM 106 may generate commands associated with causing the robot to travel in a particular direction. Such commands may be provided to a wheel controller of the physical robot, causing the physical robot to activate its wheels for traveling in the particular direction. Accordingly, the RFM 106 may be associated with providing functionality of the physical robot associated with traveling through the physical environment.

Now describing corresponding examples in the virtual environment, the RFM 106 may receive as an input virtual sensor data associated with sensing the virtual test environment. The virtual sensor data may be generated, and/or provided to the RFM 106, via the language model 102, the simulation platform 104, a virtual sensor of the virtual test environment associated with the RFM 106, and/or in any other suitable manner. In response to receiving the virtual sensor data, the RFM 106 may generate as an output commands associated with generating a map of the virtual test environment. The simulation platform 104 may interpret the commands output by the RFM 106, and in response cause a map to be generated. For example, the simulation platform 104 may simulate the performance of the mapping subsystem of the physical robot based upon processing the commands output by the RFM 106. This may include causing the simulation platform 104 to generate the map by simulating the mapping system functionality, causing a virtual mapping subsystem of the virtual test environment to receive the commands and generate the map, and/or performing any other suitable method of generating the map based upon the commands output by the 106. In another scenario, the RFM 106 of the virtual test environment may be configured with a virtual mapping system that simulates the mapping system of the physical robot, and/or be configured to communicate with the virtual mapping system of the virtual test environment that models the mapping system of the physical robot. Thus, the RFM 106 may be associated with providing functionality associated with generating maps of the virtual test environment. In another example the RFM 106 may be deployed on a virtual mission that includes instructions to travel from a mission start location of the virtual test environment to a mission end location along the safest path. In response to receiving the virtual mission instructions an input, the RFM 106 may generate as an output commands that would cause the physical robot to actuate a locomotive component (e.g., wheels). The simulation platform 104 may process the commands output by the RFM 106, and in response cause the RFM 106 travel in a particular direction within the virtual test environment. This may include the simulation platform 104 simulating travel of the RFM 106 through the virtual test environment based upon the commands, providing the commands to a virtual wheel controller to activate virtual wheels associated with the RFM 106, and/or causing the RFM 106 to travel in the particular direction in any other suitable manner. Accordingly, the RFM 106 may be associated with providing functionality associated with traveling through the virtual test environment.

As just described, the RFM 106 may be associated with implementing, controlling, and/or otherwise providing functionality of the physical robot in the physical environment that can be simulated in one or more ways in the virtual test environment of the simulation platform 104. Accordingly, the RFM 106 may generally be referred to herein as being the robot in the virtual environment of the simulation platform 104, being a digital twin of the physical robot in the virtual test environment, having functionality in the virtual test environment that corresponds to and/or otherwise simulates the functionality of the physical robot, and the like. As the functionality of the physical robot may be simulated in the virtual test environment in one or more ways previously described, it should be understood that when referring the RFM 106 in the virtual environment as being and/or corresponding to the physical robot, simulating the functionality of the physical robot in the virtual test environment may include simulating components, devices, and the like associated with the physical robot (e.g., wheel controllers, mapping subsystems) via the simulation platform 104 in a manner that may not be explicitly be described.

The virtual test environment may be configured with the same and/or similar characteristics as a physical environment, such as a corresponding physical test environment. In such a scenario, the virtual mission may test the performance of the RFM 106, such as testing performance associated with a particular robot model or policy of the robot that is simulated by the RFM 106. The performance of the RFM 106 in the virtual test environment may indicate the performance of the corresponding physical robot in a physical environment that is similar to the virtual environment. The performance of the RFM 106 in the virtual test environment may be indicated by virtual operation characteristics of the RFM 106. The virtual operation characteristics may be generated via the RFM 106 and/or the simulation platform 104. For example, the virtual operational characteristics may indicate and/or otherwise be associated with an amount of time to complete the virtual mission, an amount of information gain (e.g., information obtained by the RFM 106 experiencing the virtual environment, such as virtual sensor data) of the RFM 106 during the virtual mission, collaboration between multiple RFMs 106 during the virtual mission, a simulated hardware characteristics (e.g., operation of a virtual servo, the position of a virtual limb, hardware faults) of the RFM 106, a simulated software characteristics (e.g., coding error, software fault such as an operating system crash) of the RFM 106, and/or other suitable virtual operational characteristic of the RFM 106. The RFM 106 may generate data in the virtual test environment indicating the virtual operational characteristics. For example, the virtual operational characteristics may be indicated by commands generated as an output by the RFM 106 during the virtual mission (e.g., commands to actuate a limb). In another example, the simulation platform 104 may generate data indicating the virtual operational characteristics, for example when generating data via a physics engine of the simulation platform 104 that indicates a simulated force of impact between the RFM 106 and a virtual obstacle of the virtual test environment.

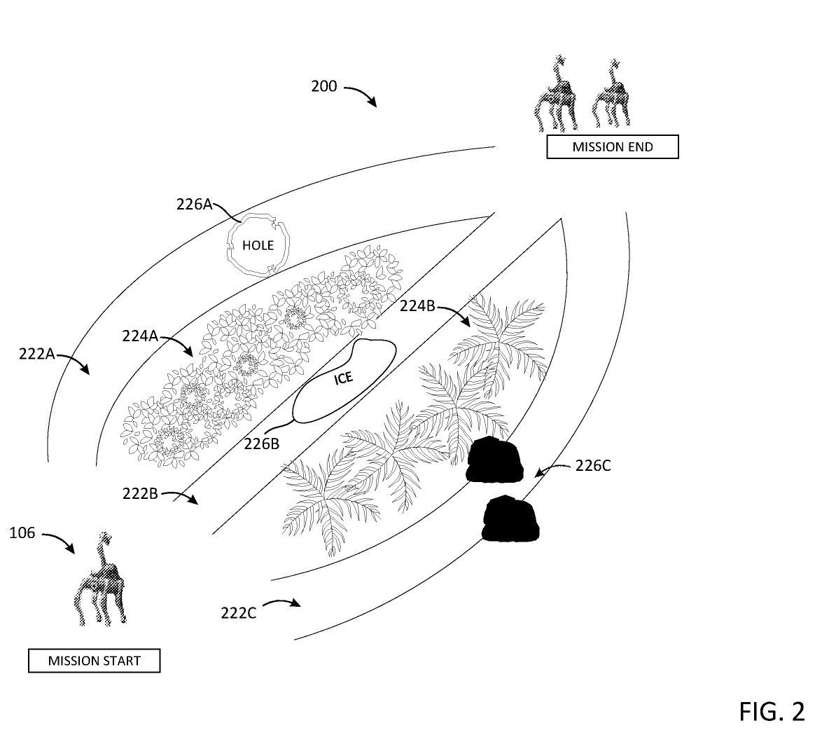

FIG. 2 depicts an example virtual test environment 200 in one implementation of the instant application. The language model 102 may generate API data that indicates the characteristics of the virtual test environment 200. For example, the API data may indicate the virtual test environment 200 includes three paths 222A, 222B, 222C connecting a starting location of a virtual mission and an ending location of the virtual mission. The API data may indicate obstacles of the virtual test environment 200. The obstacles may include a first set of plants 224A between the first path 222A and the second path 222B and a second set of plants 224B between the second path 222B and the third path 222C. The obstacles may include a hole 226A located on the first path 222A, an ice patch 226B located on the second path 222B, and boulders 226C located on the third path 222C. The language model 102 may transmit the API data associated with generating the virtual test environment 200 to the simulation platform 104 via one or more API calls, causing the simulation platform 104 to generate the virtual test environment 200. In at least some implementations, the simulation platform 104 may transmit data back to the language model 102 (e.g., responses to one or more API calls to the simulation platform 104) associated with generation of the virtual test environment 200. For example, in response to receiving API data from the language model 102 to configure the virtual test environment with an obstacle, the simulation platform 104 may send a response to the language model 102 confirming the obstacle was generated.

The RFM 106 may perform a virtual mission within the virtual test environment 200. In one example, the RFM 106 may perform a virtual mission that includes traversing the virtual test environment 200 along one of the paths 222A-222C that provides the safest route from the mission starting position to the mission ending position. In such an example, the RFM 106 may traverse the first path 222A and upon encountering the hole 226A, probe the hole 226A to determine how wide and deep the virtual hole 226A is for assessing whether the RFM 106 can safely traverse the hole. Probing the hole 226A may include implementing virtual sensors and/or virtual limbs that associated with the RFM 106, such as virtual sensors and/or virtual limbs simulated by the RFM 106 itself, simulated by virtual sensor models and/or virtual limb models of the virtual test environment, simulated by the simulation platform 104 (e.g., based upon processing commands generated by the RFM 106 to probe the hole 226A and generating synthetic sensor data provided to the RFM 106 that simulates sensor data of physical sensors and physical limbs when probing a physical hole), and/or in any other suitable manner. As the RFM 106 traverses the first path 222A, probes the hole 226A, and/or otherwise performs the virtual mission, the simulation platform 104 and/or the RFM 106 may generate virtual operational data. The virtual operational data may indicate virtual operational characteristics of the RFM during the virtual mission (e.g., simulated computing resource usage, virtual hardware faults experienced while performing the virtual mission), information associated with the virtual test environment of the virtual mission (e.g., the configuration of the virtual test environment), and/or other suitable information associated with the RFM 106 performing the virtual mission (e.g., the time to complete the virtual mission, the robot under test, the policy under test, etc.).

The virtual sensor data may be provided as an input to the RFM 106 while performing the virtual mission. This may simulate the RFM 106 receiving sensor data as an input from physical sensors of a physical robot performing a mission in a physical test environment. For example, the virtual sensor data may simulate the RFM 106 sensing the virtual test environment during the virtual mission. The RFM 106 may generate the virtual operational data based upon receiving the virtual sensor data while performing the virtual mission. For example, the virtual sensors may generate virtual sensor data such as odometry data as the RFM 106 travels, data from virtual vision and depth sensors probing the hole 226A, data from virtual actuators controlling the virtual limbs of the RFM 106, etc. The associated virtual operational data may indicate what the RFM 106 learns from the virtual sensor data (e.g., identification of five objects), what the RFM 106 generates as an output (e.g., commands) in response to receiving the virtual sensor data, etc. Performing the virtual mission may include the RFM 106 similarly traversing the second path 222B and probing the ice patch 226B, and traversing the third path 222C and probing the boulders 226C. Such virtual mission performance may generate associated virtual operational characteristic data, such as data indicating friction and/or slippage between a virtual locomotive components (e.g., wheels, treads, legs) of the RFM 106 and the ice patch 226B, the amount of clearance between the boulders 226C, the amount of time taken to traverse all three paths 222A-222C, whether the RFM 106 was able to successfully reach the virtual mission end location along any of the paths 222A-222C, the amount of virtual power used by the RFM 106 during the virtual missions, how much information was gained by the RFM 106 (e.g., via its sensors) during the virtual mission, etc.

Returning to FIG. 1, the workflow 100 may include a performing a performance analysis 108 of the performance of the RFM 106 during the virtual mission as indicated by the associated virtual operational data. The performance analysis 108 may be performed via one or more devices and/or components, such as via an evaluation engine implementing one or more programs, algorithms, models (e.g. the language model 102), subsystems (e.g., a fault identification subsystem, a weakness identification subsystem), as further described herein. The performance analysis 108 may include anomaly detection via unsupervised predictive learning, for example as described in the publication Dey, Sharmita, et al. “Prepare: Predictive proprioception for agile failure event detection in robotic exploration of extreme terrains.” 2022 IEEE/RSJ International Conference on Intelligent Robots and Systems (IROS). IEEE, 2022. The performance analysis 108 may include a multi-agent interaction analysis which applies game-theoretic perspectives to understand and evaluate interactions among multiple RFMs 106, for example as described in the publication Tuyls, Karl, et al. “Game Plan: What AI can do for Football, and What Football can do for AI.” Journal of Artificial Intelligence Research 71 (2021): 41-88. In at least some implementations, the performance analysis 108 may include a human user in the loop, such as a user that reviews the results of an automated performance analysis to determine whether the results are reasonable and/or accurate, a user that performs the entire performance analysis 108 based upon review of the virtual operational characteristics during the virtual mission, etc.

The performance analysis 108 may include obtaining the virtual operational data. The virtual operational data may be obtained via the simulation platform 104, for example virtual operational data generated by the RFM 106 while performing the virtual mission that is obtained from the RFM 106 via the at the simulation platform 104 and/or generated by the simulation platform 104 itself, as previously described, and/or in any other suitable manner (e.g., retrieving the virtual operational data stored in a database). The virtual operational data may indicate one or more virtual operational characteristics of the RFM 106 during the virtual mission, such as descriptions or otherwise identification of the operational characteristics at one or more times during the virtual mission, one or more values or otherwise metrics associated with the operational characteristics, testing criteria associated with the operational characteristics (e.g., acceptable and/or unacceptable operational characteristics and/or associated values and/or metrics), and/or any other suitable information associated with the virtual operational characteristics of the RFM 106 during the virtual mission. The performance analysis 108 may include analyzing (e.g., via the evaluation engine) at least the virtual operational data to determine whether the virtual operational data indicates a virtual operational characteristic for further testing. The performance analysis 108 may include identifying at least one virtual operational characteristic of the RFM 106 for further testing based upon determining the operational characteristics to be further tested did not satisfy the associated virtual testing criteria. For example, the performance analysis 108 may include analyzing virtual operational data that indicates whether RFM 106 followed a planned paths when traversing the virtual test environment, whether the RFM 106 became stuck during its travels, whether the RFM 106 collided with objects of the virtual test environment. The performance analysis 108 may include evaluating the trajectory of the RFM 106 during the virtual mission by comparing the trajectory indicated by the virtual operational data with a ground truth trajectory (e.g., the associated test criteria) defined as the optimal path of travel during the virtual mission. The performance analysis 108 may include analyzing whether multiple robots performing the virtual mission in the virtual test environment applied strategic reasoning methods (e.g., game-theoretical analyses) during multi-robot interactions and decision-making. The same types of analyses may be performed when the test environment is a physical test environment for testing physical robots, as further described herein.

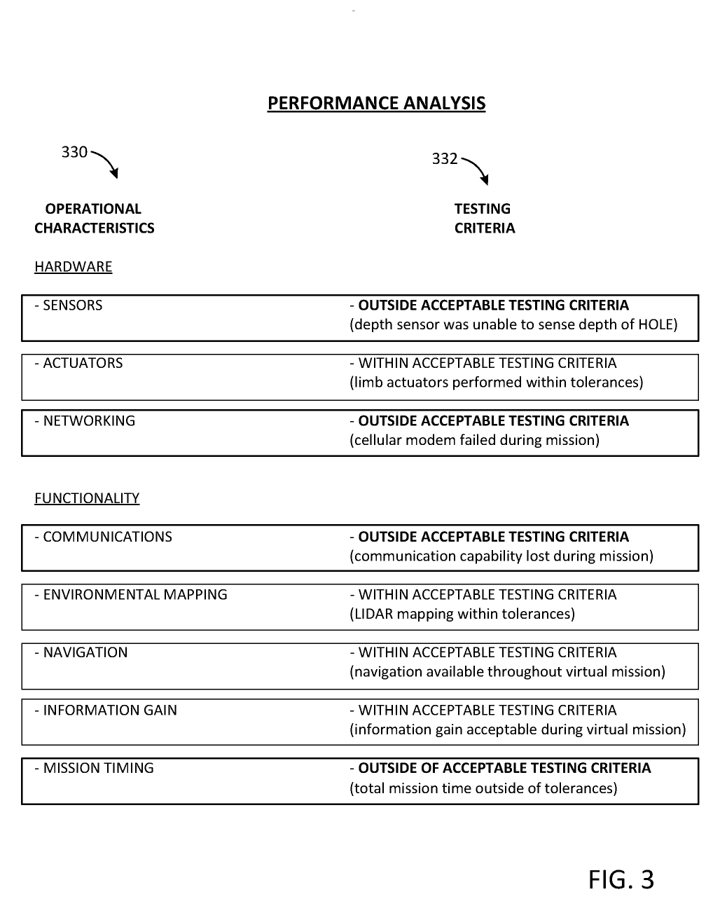

FIG. 3 depicts example information associated with a performance analysis (e.g., the performance analysis 108) of RFM 106 during a virtual mission, in one implementation of the instant application. The performance analysis information may include and/or otherwise indicate information associated with the virtual operational data (e.g., based upon virtual sensor data of the RFM 106 while performing the virtual mission), such as virtual operational characteristics 330 of the RFM 106 during the virtual mission (e.g., based upon the virtual operational data), associated testing criteria 332. As one example, the performance analysis indicates the virtual sensors of the RFM 106 operated outside of acceptable testing criteria because the depth sensor was unable to sense the depth of the hole 226A during probing. In another example, the total time to complete the mission was outside of acceptable tolerances (e.g., time limits). However, the performance analysis may include any suitable information associated with the performance of the RFM 106 during the virtual mission, such as information associated with the virtual operational data such as values of the operational characteristics of the RFM 106 (e.g., values that were within and/or outside of tolerances associated with the testing criteria), rules, guidelines, and/or otherwise information used to perform the performance analysis, etc.

When no virtual operational characteristics are identified for further testing based upon the performance analysis 108, the workflow 100 may end. The performance analysis 108 may indicate one or more virtual operational characteristics for further testing, and the workflow 100 may include inputting the virtual operational data to the language model 102. In response to receiving the virtual operational data indicating at least one virtual operational characteristic for further testing, the language model 102 may reconfigure the virtual test.

In at least some implementations, the virtual operational data may further include and/or otherwise indicate information generated based upon the performance analysis 108, referred to herein at times as performance analysis data. The performance analysis data may include and/or indicate the current and/or previous configurations of the virtual test environment, for example by indicating and/or including the virtual test environment data associated with the current and/or previous configurations of the virtual test environment. The performance analysis data may include and/or indicate how the current test environment is to be reconfigured, for example by indicating the characteristics and/or associated characteristic values of the current test environment to adjust or otherwise reconfigured to generate the reconfigure test environment. The performance analysis data may include and/or indicate any other suitable data associated with performing the performance analysis 108.

Reconfiguring the virtual test environment may be based upon a current configuration and/or one or more previous configurations of the virtual test environment and its characteristics, for example previous configurations in which the same virtual mission was performed by the RFM 106. Accordingly, to reconfigure the virtual test environment, the language model 102 may require knowledge of the current configuration and/or previous configuration(s) of the virtual test environment. The language model 102 may obtain this information in any suitable manner. For example, the language model 102 may have generated the current and/or previous configurations of the virtual test environment based upon generating associated test environment data which is accessible to the language model 102 when reconfiguring the virtual test environment. In another example, the virtual operational data may indicate the current and/or previous configurations of the virtual test environment. For example, the virtual operational data input to the language model 102 may include the aforementioned performance data that indicates and/or otherwise includes test environment data associated with the current and/or previous configurations of the virtual test environment input. In yet another example, language model 102 may obtain the test environment data associated with the current and/or previous configurations of the virtual test environment from another computing device (e.g., a server) and/or component (e.g., a database storing test environment data) when reconfiguring the virtual test environment.

The language model 102 may determine how to adjust one or more characteristics of the virtual test environment to further test the operational characteristic identified for further testing based upon the performance analysis 108, for example to enable more effective stress testing of the identified operational characteristic. In one scenario, the performance analysis 108 may identify and/or otherwise indicate (e.g., in the associated performance analysis data) one or more operational characteristics that did not satisfy associated testing criteria, which may be referred to as “weak points,” requiring further testing (e.g., in a reconfigured test environment). Using an example of FIGS. 2 and 3, the performance analysis 108 may indicate the RFM 106 was unable to sense the depth of the hole 226A of the current test environment. The language model 102 may receive as an input the virtual operational data that indicates the virtual operational characteristics for further testing and also includes the performance analysis data indicating the depth-sensing issue. In response to receiving the virtual operational data, the language model 102 may reconfigure the virtual test environment with a hole that is less deep than the hole 226A of the current virtual test environment. The reconfigured virtual test environment with the less deep hole may be able to indicate a limit of the depth sensing operational characteristics of the RFM 106.

In another scenario, the performance analysis 108 may identify and/or otherwise indicate (e.g., in the performance analysis information included in the virtual operational data) one or more operational characteristics that did satisfy associated testing criteria and will nonetheless undergo further testing. In such a scenario, the RFM 106 may perform a first virtual mission and be subsequently reconfigured (e.g., retrained) to improve the performance of an operational characteristics that is within tolerances and satisfies testing criteria during the first mission, such as faster LIDAR environmental mapping that improves navigation of the RFM 106. The language model 102 may receive the virtual operational data (e.g., that indicates the virtual operational characteristics for further testing and may include the performance analysis) data as an input, and in response reconfigure the virtual test environment to be more complex environment (e.g., additional obstacles) to determine whether the LIDAR environmental mapping and/or navigation of the RFM 106 is improved.

In yet another scenario, the language model 102 may reconfigure the virtual test environment to test the limitations of a virtual operational characteristic that was within acceptable testing criteria to determine when the operational characteristic is no longer within acceptable test criteria. For example, the RFM 106 may have been able to successfully navigate between the boulders 226C in the virtual test environment, causing the language model 102 to reconfigure the virtual test environment based upon the performance analysis 108 with boulders 226C having less clearance between the boulders 226C to further test the navigation abilities of the RFM 106. The language model 102 may reconfigure the virtual test environment in any other suitable manner based at least upon information provided in the performance analysis 108. The language model 102 may receive additional information associated with reconfiguring the virtual test environment, such as feedback from a user performing at least a portion of the performance analysis 108. Accordingly, the workflow 100 may provide a closed feedback loop for testing of the RFM 106 in multiple virtual test environments.

It should be understood that while FIGS. 1-3 generally describe testing performance of a single RFM 106, this is for ease of illustration. The virtual test environment may be configured to test the performance of multiple robots via the simulation platform 104. In one example, the virtual test environment may be configured to test multiple robots, at least some of which are performing the same virtual mission or different virtual missions. In such a scenario, the performance analysis 108 may include analyzing the performance of a single RFM 106 during the mission and/or the performance of multiple RFMs 106. For example, the performance analysis 108 may include determining whether the collective performance of multiple RFMs 106 was within testing criteria, such as whether multiple RFMs 106 accomplished a virtual mission together within a requisite amount of time, whether each RFM 106 successfully arrived at the mission destination via one or more paths, etc.

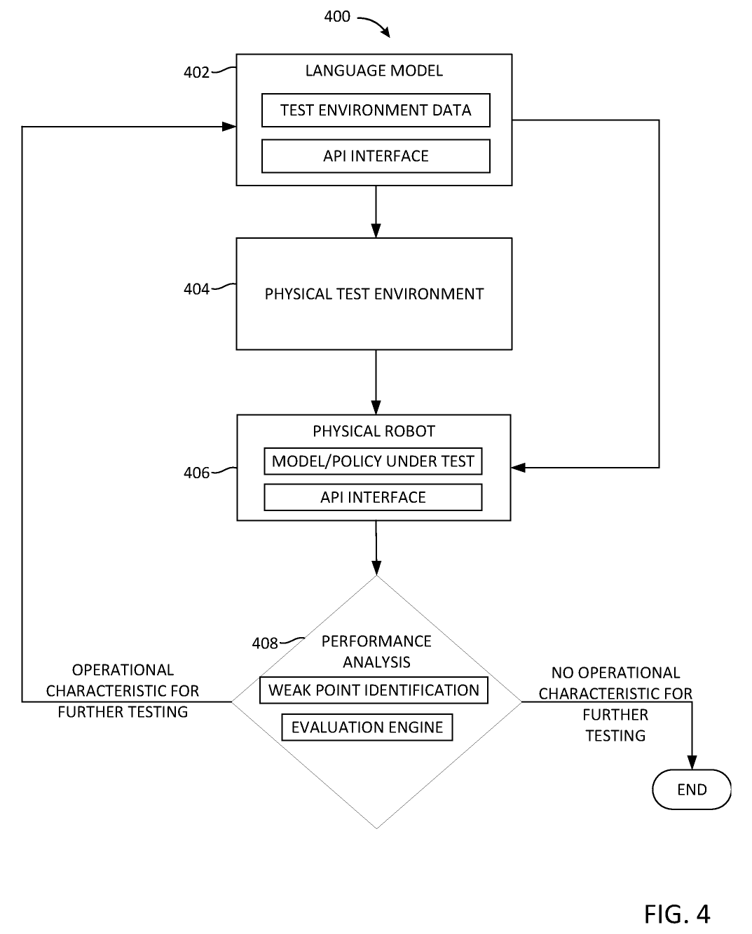

Generating test environments to optimize performance of robots may include generating physical (e.g., non-virtual) test environments for testing physical robots. FIG. 4 is a block diagram of an example workflow 400 for generating physical test environments to optimize performance of robots, in one implementation of the instant application. For example, the workflow 400 may be performed to test the performance of a physical robot corresponding to RFM 106 (e.g., a physical robot having the same and/or similar capabilities as the RFM 106) in a physical environment that mimics or otherwise simulates the virtual test environment.

Similar to the workflow 100, a language model 402 (e.g., the language model 102) may generate test environment data (e.g., code, instructions, text, descriptions, images, video, etc.) describing and/or otherwise indicating (e.g., textually describe, visually depict) characteristics of the physical test environment 404. The physical test environment 404 may be created and/or otherwise configured based upon the test environment data. For example, the In at least some implementations, the language model 402 may be configured to communicate with the physical robot 406 via the previously described API. The language model 402 may generate API data that, when transmitted and processed by the physical robot 406, allows the language model 402 to configure, control, and/or otherwise affect the performance of the physical robot 406. For example, the language model 402 may generate API data that causes the physical robot 406 to perform the mission, implement specific functionality (e.g., perform particular tasks during the mission in a particular manner), cause interference with the mission (e.g., by simulating a hardware or functionality issues), etc. This may include causing one or more physical robots 406 to create at least a portion of the physical test environment 404.

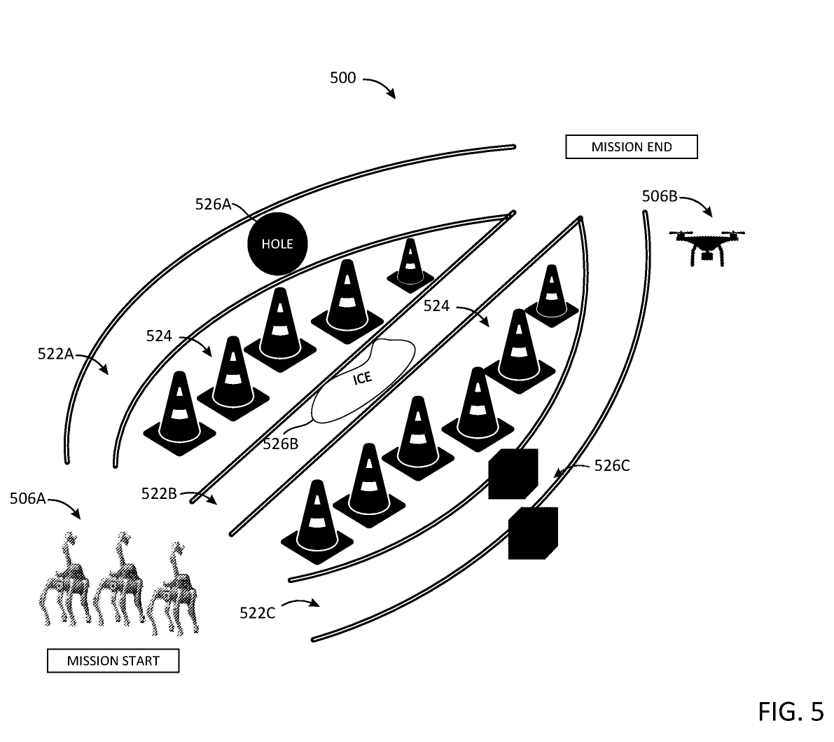

FIG. 5 depicts an example physical test environment 500 (e.g., the physical test environment 404) for testing multiple physical robots 506A (e.g., quadruped robots), in one implementation of the instant application. The physical test environment 500 may be configured to simulate the virtual test environment 200, for example to test coordination between the physical robots 506A in performing a mission (e.g., non-virtual mission associated with a robot model or policy under test) in the physical test environment 500. For example, the physical test environment 500 may include three physical paths 522A-522C created by laying ropes on a physical surface (e.g., floor) of the physical test environment 500. To simulate the first set of virtual plants 224A and the second set of virtual plants 224B creating obstacles between the virtual paths 222A-222C, the physical test environment 500 may include traffic cones 524 creating similar obstacles between the three physical paths 522A-522C. The physical test environment 500 may include a hole 526A (e.g., trap door) in the flooring surface of the first physical path 522A to simulate the virtual hole 226A, a physical ice patch 526B on the second physical path 522B to simulate the virtual ice patch 226B, and a pair of boxes 526C on the third physical path 522C to simulate the virtual boulders 226C. In one example, the mission associated with the physical test environment 500 may include the three physical robots 506A traversing the physical test environment 500 using the three physical paths 522A-522C to arrive at the mission end location, such that two physical robots 506A traverse the same physical path 522A-522C.

The language model 402 may cause one or more physical robots 406, referred to at times herein as adversarial physical robots, to create, provide or otherwise cause adverse conditions for the physical robots 406 performing the mission in the physical test environment 404. The adverse condition may be associated with a hardware issue of the physical robot 406 (e.g., causing interference with the movement of limbs of the physical robot 406 performing the mission), a software issue of the physical robot 406 (e.g., jamming radio frequencies to create a failure in communication between physical robots 406 during the mission), a physical interference with the physical robot 406 (e.g., causing a second physical robot to push obstacles into the path of travel of other physical robots 406 to create navigation obstacles), and/or any other suitable adverse condition associated with the performance of the mission. For example with reference to FIG. 4, the physical test environment 500 may include an adversarial physical robot 506B (e.g., unmanned drone). The language model 402 may control and/or otherwise conFIGURE(e.g., via API calls) the adversarial physical robot 506B to spray water on the second physical path 522B that is frozen to create the ice patch 526B, causing the adversarial physical robot 506B to push the boxes 526C onto the third physical path 522C to create obstacles for the multiple physical robots 506A, etc.

The physical robots 506A may generate (e.g., individually and/or collectively as a fleet) operational data indicating operational characteristics of the physical robots 506A during the mission in the physical test environment 404, similar to the virtual operational data indicating virtual operational characteristics of the RFM 106 during the virtual mission in the virtual test environment 200. For example, the operational characteristics may indicate whether the physical robots 506A worked as a team in performing the mission by implementing strategic reasoning methods (e.g., game-theoretical analyses) based upon multi-robot interactions and efficient decision-making. In another example, the operational characteristics may indicate whether all of the physical robots 506A competed the mission within a particular amount of time.

The workflow 400 may include a performance analysis 408 of the operational data of the physical robots 506A similar to the performance analysis 108 of the virtual operational data of the RFM 106. The performance analysis 408 may determine (e.g., via an evaluation engine) whether the operational characteristics of the physical robots 506A satisfy associated testing criteria. As the performance analysis 408 may include analyzing the performance of the physical robot 506A individually and as a team, the performance analysis 408 may be more complex (e.g., exponentially more complex) than a performance analysis of a single physical robot 506A. This may also be the case respective to the performance analysis 108 of multiple RFMs 106 being more complex than the performance analysis 108 of a single RFM 106 during a virtual mission.

The results of the performance analysis 408 may identify one or more operational characteristics for further testing. In one example, the operational data may indicate operational characteristics having sub-par performance (e.g., weak points) of the physical robots 506A that needs to be improved and thus are identified for further testing. In another example, for instance of a mission designed to test the limits of the operational characteristics of the physical robots 506A, the operational data may indicate five of six operational characteristics of the physical robots 506A operated as normal. The associated testing criteria may indicate that all six of the operational characteristics of the physical robots 506A should fail. In such an example, the performance analysis 408 may indicate the five operational characteristics that did not fail should undergo further testing, for example in a more complex test environment (e.g., indicated by the test environment data generated by language model 102) that focuses on pushing the five operational characteristics to more extreme limits.

If operational characteristic(s) are identified for further testing, the operational data (e.g., including performance analysis data associated with the performance analysis 408) may be provided as an input to the language model 402. In response, the language model 402 may generate test environment data for reconfiguring the physical test environment 404 for further testing of the physical robots 406, such as further testing of particular operational characteristics identified based upon the performance analysis 408. If no operational characteristics are identified for further testing based upon the performance analysis 408, the workflow 400 may end.

In at least some implementations, the language model 402 may be configured to generate (e.g., based upon one or more operational characteristic identified for further testing), robot configuration data. The robot configuration data may be used for reconfiguring a corresponding physical robot 406 to improve the at least one operational characteristic of the physical robot 406. For example, the robot configuration data may cause an improvement of the operational characteristics for further testing during performance of the mission in a physical test environment 404. The language model 402 may reconFIGURE(e.g., via the API interface) the physical robot 406 using the robot configuration data.

In at least some implementations, implementing the language model (e.g., the language model 102, 402) to perform one or more functions (e.g., generate test environment data, perform the performance analysis (e.g., the performance analysis 108, 408), generate performance analysis data, generate robot configuration data, etc.) may include performing prompt engineering. The data input into the language model may include one or more prompts including commands and/or otherwise instructions for the language model associated with performing a function. The prompt engineering may include crafting a prompt in a manner which affects the performance (e.g., improves) when performing the function. For example, when performing the performance analysis, the (virtual) operational data may include, and/or may be input to the language model with one or more prompts which cause the language model to summarize the current test environment, provide the rationale behind identifying operational characteristics for further testing, provide the rationale why reconfiguring particular characteristics of the test environment will further test a weak point of the robot, etc. The prompt engineering may further cause the language model to include such information (e.g., performance analysis information) in the (virtual) operational data upon completion of the performance analysis.

It should be understood that while FIGS. 4-5 generally describe testing performance of a fleet of physical robots, this is for ease of illustration. The physical test environment may be configured to test the performance of a single robot, similar to performance testing described with respect to the virtual environment of FIGS. 1-3.

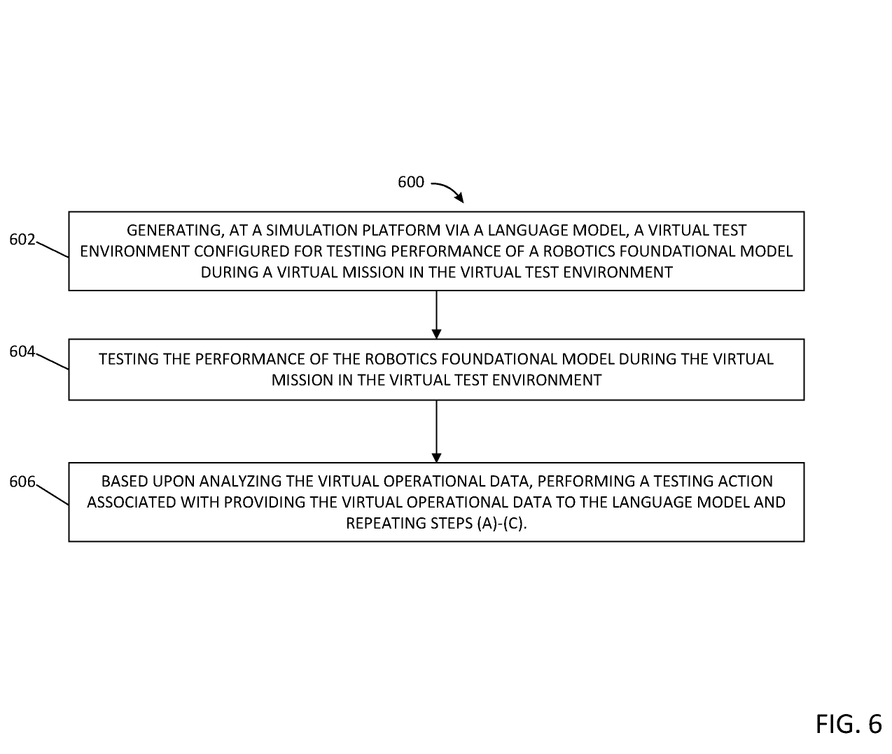

FIG. 6 is a flow diagram depicting an example computer-implemented method 600 for generating virtual test environments to optimize performance of robots, in one implementation of the instant application. One or more steps of the computer-implemented method 600 may be implemented as a set of instructions stored on a computer-readable memory and executable via one or more local or remote processors, and/or other electronic or electrical components, which may be in wired or wireless communication with one another, such as those depicted in FIG. 7.

The computer-implemented method 600 may include generating, at a simulation platform (e.g., the simulation platform 104) via a language model (e.g., the language model 102), a virtual test environment (e.g., the virtual test environment 200) configured for testing performance of a robotics foundational model (RFM) (e.g., the RFM 106) during a virtual mission in the virtual test environment (block 602). The virtual test environment may simulate a physical environment (e.g., the physical test environment 500) and/or may be configured to one or more of: simulate an atypical physical environment, test subpar performance of the at least one RFM indicated by at least one virtual operational characteristic, test improved performance of the at least one RFM associated with the at least one virtual operational characteristic, test a policy under test of the at least one RFM, test a model under test of the at least one RFM, or test collaboration of multiple RFMs. The RFM may simulate a corresponding physical robot (e.g., the physical robot 406). The RFM may be configured to perform a virtual mission in the virtual test environment.

In at least some implementations of the computer-implemented method 600, generating the virtual test environment at the simulation platform via the language model (block 602) may include determining a virtual characteristic of the virtual test environment based upon one or more of: the RFM, the virtual mission, or the virtual operational characteristic indicated for further testing in the virtual operational data; generating application programming interface data associated with configuring the virtual test environment with the virtual characteristic; and transmitting, via the language model, the application programming interface data to the simulation platform to configure the virtual test environment with the virtual characteristic. In some such implementations, the computer-implemented method 600 may include identifying, from a plurality of fine-tuned language models, one or more fine-tuned language models for configuring the virtual characteristic of the virtual test environment; and causing each of the one or more identified fine-tuned language models to generate a respective application programming interface dataset of the application programming interface data for configuring the respective virtual characteristic of the virtual test environment.

The computer-implemented method 600 may include testing the performance of at the RFM during the virtual mission in the virtual test environment (block 604). Testing the performance of at least one RFM may include: a) executing, via the simulation platform, the virtual test environment causing the RFM to perform the virtual mission in the virtual test environment; (b) obtaining virtual operational data associated with the performance of the RFM during the virtual mission, the virtual operational data indicating one or more virtual operational characteristics of the RFM during the virtual mission, wherein the one or more virtual operational characteristics of the RFM correspond to one or more respective operational characteristics of the physical robot; and (c) analyzing the virtual operational data to determine whether the virtual operational data indicates a virtual operational characteristic for further testing of the one or more virtual operational characteristics. The virtual operational characteristics of the RFM during the virtual mission may be associated with one or more of: an amount of time to complete the virtual mission, an information gain of the RFM during the virtual mission, collaboration between multiple RFMs during the virtual mission, a simulated hardware characteristics of the RFM, or a simulated software characteristics of the RFM.

The computer-implemented method 600 may include, based upon analyzing the virtual operational data, performing a testing action associated with providing the virtual operational data to the language model and repeating steps (a)-(c) (block 606).

In at least some implementations of the computer-implemented method 600, analyzing the virtual operational data may determine the virtual operational data does not indicate the virtual operational characteristic for further testing. In some such implementations, performing the testing action may include: refraining from providing the virtual operational data to the language model as an input, and refraining from repeating steps (a)-(c).

In at least some implementations of the computer-implemented method 600, analyzing the virtual operational data may determine the virtual operational data indicates the virtual operational characteristic for further testing. In some such implementations, performing the testing action may include: providing the virtual operational data to the language model as an input causing the language model to reconfigure, at the simulation platform, the virtual test environment for testing the virtual operational characteristic for further testing, and repeating, via the one or more processors, steps (a)-(c). Reconfiguring the virtual test environment for testing the virtual operational characteristic for further testing may include one or more of: reconfiguring a virtual environmental condition of the virtual test environment, reconfiguring a location of a virtual object in the virtual test environment, adding a virtual obstacle to the virtual test environment, or removing a virtual obstacle from the virtual test environment.

In at least some implementations, the computer-implemented method 600 may include receiving, from the simulation platform, virtual operational data indicating the one or more virtual operational characteristics of the RFM during the virtual mission; analyzing the virtual operational data to determine whether the one or more virtual operational characteristics satisfy virtual testing criteria associated with the one or more virtual operational characteristics; and identifying the virtual operational characteristic for further testing based upon determining the virtual operational characteristic for further testing does not satisfy the associated virtual testing criteria. In some such implementations, the computer-implemented method 600 may include generating, via the simulation platform, virtual sensor data provided as an input to the RFM while performing the virtual mission, wherein the virtual sensor data is generated via one or more virtual sensors of the RFM by sensing the virtual test environment during the virtual mission; and generating, via the at least one RFM, the virtual operational data based upon receiving the virtual sensor data while performing the virtual mission.

In at least some implementations, the computer-implemented method 600 may include causing the physical robot to perform a mission in a physical test environment (e.g. the physical test environment 404) corresponding to the RFM performing the virtual mission in the virtual test environment; obtaining operational data generated via the physical robot indicating one or more operational characteristics of the physical robot during the mission; analyzing the operational data to determine whether the one or more operational characteristics satisfies a corresponding testing criteria; identifying an operational characteristic for further testing of the one or more operational characteristics based upon determining the operational characteristic for further testing does not satisfy the corresponding testing criteria; generating, based upon the operational characteristic identified for further testing, robot configuration data used for reconfiguring the physical robot to improve the operational characteristic during performance of the mission; and reconfiguring the physical robot using the robot configuration data. In some such implementations, the language model may be configured to perform one or more of: perform one or more of: cause the physical robot to perform the mission, generate the robot configuration data, or reconfigure the physical robot using the robot configuration data. In some such implementations, the computer-implemented method 600 may include causing an adverse condition for the physical robot during performance of the mission, the adverse condition associated with one or more of: a hardware issue of the physical robot, a software issue of the physical robot, a physical interference of the physical robot. The adverse condition may be caused by the language model communicating, via an application programming interface, with one or more of: the physical robot to cause the adverse condition or an adversarial physical robot causing the adverse condition.

In at least some implementations, the computer-implemented method 600 may include generating, based upon the virtual operational data, updated training data for training the RFM to improve the one or more virtual operational characteristics of the RFM during the virtual mission; and retraining the RFM using the updated training data to improve the one or more virtual operational characteristics of the RFM during the virtual mission.

It should be understood that not all blocks of the exemplary flow diagram of FIG. 6 are required to be performed.

FIG. 7 is a block diagram depicting an example computing environment 700 for generating virtual test environments to optimize performance of robots, in one implementation of the instant application. The computing environment 700 may include a system 705 communicatively coupled, via a network 710, to a database 735, a robot 740, and a computing device 760. The computing environment 700 may be implemented, used, and/or configured to perform at least a portion of the workflows 100, 400, and/or computer-implemented method 600. Although FIG. 7 depicts certain entities, components, equipment, and devices, it should be appreciated that fewer, additional and/or alternate entities, components, equipment, and/or devices may be envisioned.

The system 705 may perform functionalities associated with generating virtual test environments to optimize performance of robots, such as a robotic foundational model (RFM) (e.g., the RFM 106) and/or robot 740, such as obtaining data (e.g., sensor data, odometry data, environmental data), generating models (e.g., point clouds), configuring the robot 740, training and/or implementing a model (e.g., a machine learning model), etc. The system 705 may include, and or be part of, a cloud network or may otherwise communicate with other hardware or software components within one or more cloud computing environments to send, retrieve, or otherwise analyze data or information described herein. For example, in certain aspects of the present techniques, the computing environment 700 may include an on-premise computing environment, a multi-cloud computing environment, a public cloud computing environment, a private cloud computing environment, and/or a hybrid cloud computing environment. For example, an entity (e.g., a robotics company) may host one or more services in a public cloud computing environment (e.g., Alibaba Cloud®, Amazon Web Services® (AWS), Google Cloud®, IBM Cloud®, Microsoft Azure®, etc.). The public cloud computing environment may be a traditional off-premise cloud (i.e., not physically hosted at a location owned/controlled by the entity). Alternatively, or in addition, aspects of the public cloud may be hosted on-premises at a location owned/controlled by the entity. The public cloud may be partitioned using visualization and multi-tenancy techniques and may include one or more infrastructure-as-a-service (IaaS) and/or platform-as-a service (PaaS) services.

The system 705 may include at least one processor 702. The processor 702 may include one or more computational circuits, including, but not limited to, one or more central processing units (CPUs), microprocessor units, microcontrollers, complex instruction set computing (CISC) microprocessor units, reduced instruction set computing microprocessor (RISC) units, very long instruction word microprocessor units, explicitly parallel instruction computing microprocessor units, graphics processing units (GPUs), digital signal processing (DPS) units, or any other type of processing circuit. The processor 702 may also include embedded controllers, such as generic or programmable logic devices or arrays, application-specific integrated circuits (ASICs), single-chip computers, and the like. The processor 702 may be connected to a memory 704 via a computer bus (not depicted) responsible for transmitting electronic data, data packets, and/or otherwise electronic signals to and from the processor 702 and the memory 704 in order to implement or perform the machine-readable instructions, methods, processes, elements, or limitations, as illustrated, depicted, or described for the various flowcharts, illustrations, diagrams, figures, and/or other disclosure herein. The processor 702 may interface with the memory 704 via a computer bus to execute an operating system and/or computing instructions contained therein, and/or to access other services/aspects. For example, the processor 702 may interface with the memory 704 via the computer bus to create, read, update, delete, or otherwise access or interact with the data stored in the memory 704 and/or the database 735.

The system 705 may include at least one network interface 706. The network interface 706 may allow the system 705 to communicate over the network 710, for example via any suitable wired and/or wireless connection. The network interface 706 may include one or more hardware, firmware, and/or software components (e.g., Ethernet cards, Wi-Fi adapters, cellular modems). The network interface 706 may include one or more transceivers (e.g., wireless wide area network (WWAN), wireless local area network WLAN, and/or wireless personal area network (WPAN) transceivers) functioning in accordance with IEEE® standards, 3GPP® standards, and/or other standards, and that may be used in receipt and transmission of data (e.g., via external/network ports connected to the network 710).

The system 705 may include at least one user interface 708. The user interface 708 may include one or more components and/or devices to receive an input and/or generate an output. The user interface 708 may include one or more of a keyboard, a mouse, a display (e.g., liquid crystal display (LCD), organic light-emitting diode (OLED) display), a touchscreen, a microphone, a speaker, an imaging device, a button, a switch, and/or other suitable components or device for to receiving an input and/or generating an output.

The memory 704 may include one or more forms of volatile and/or non-volatile, fixed and/or removable memory, such as read-only memory (ROM), electronic programmable read only memory (EPROM), random access memory (RAM), erasable electronic programmable read-only memory (EEPROM), compact disks, digital video disks, diskettes, magnetic tape cartridges and/or other hard drives, flash memory, MicroSD® cards, and others. The memory 704 may store an operating system (e.g., Microsoft Windows®, Linux®, UNIX®, etc.) capable of facilitating the functionalities, apps, methods, or other software as discussed herein. In general, a computer program or computer based product, application, or code (e.g., ML models or other computing instructions described herein) may be stored on a machine-readable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor 702 (e.g., working in connection with the respective operating system in memory 704) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang®, Python®, C®, C++®, C#®, Objective-C®, Java®, Scala®, ActionScript®, JavaScript®, HTML®, CSS®, XML®, etc.).

The memory 704 may store at least one computing module 712. The computing module 712 may be implemented as respective sets of computer-executable instructions (e.g., one or more source code libraries) as described herein. A component or device (standalone, client or distributed computer or computing system) configured by an application may constitute a computing module 712, also referred to herein at times interchangeably as a “subsystem” or “module,” that is configured and operated to perform certain operations. In one implementation, the computing module 712 may be implemented mechanically or electronically. The computing module 712 may include dedicated circuitry or logic that is permanently configured (within a special-purpose processor) to perform certain operations. In another implementation, the computing module 712 may also include programmable logic or circuitry (as encompassed within a general-purpose processor or other programmable processor) that is temporarily configured by software to perform certain operations. Accordingly, the term computing module 712 should be understood to encompass a tangible entity, be that an entity that is physically constructed permanently configured (hardwired) or temporarily configured (programmed) to operate in a certain manner and/or to perform certain operations described herein.

The computing module 712 may include an ML module 714. The ML module 714 may perform ML model training and/or operation. In at least some implementations, at least one of a plurality of ML methods and algorithms may be applied by the ML module 714, which may include, but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various implementations, the implemented ML methods and algorithms are directed toward at least one of a plurality of categorizations of ML, such as supervised learning, unsupervised learning, and reinforcement learning. In one aspect, the ML based algorithms may be included as a library or package executed on the system 705. For example, libraries may include the TensorFlow® based library, the PyTorch® library, and/or the scikit-learn Python® library.

In one implementation, the ML module 714 employs supervised learning, which involves identifying patterns in existing data to make predictions about subsequently received data. Specifically, the ML module 714 is “trained” using training data, which includes exemplary inputs and associated exemplary outputs. Based upon the training data, the ML module 714 may generate a predictive function which maps outputs to inputs and may utilize the predictive function to generate ML outputs based upon data inputs. The exemplary inputs and exemplary outputs of the training data may include any of the data inputs or ML outputs described above. In the exemplary implementations, a processing element may be trained by providing it with a large sample of data with known characteristics or features.

In another implementation, the ML module 714 may employ unsupervised learning, which involves finding meaningful relationships in unorganized data. Unlike supervised learning, unsupervised learning does not involve user-initiated training based upon exemplary inputs with associated outputs. Rather, in unsupervised learning, the ML module 714 may organize unlabeled data according to a relationship determined by at least one ML method/algorithm employed by the ML module 714. Unorganized data may include any combination of data inputs and/or ML outputs as described above.

In yet another implementation, the ML module 714 may employ reinforcement learning, which involves optimizing outputs based upon feedback from a reward signal. Specifically, the ML module 714 may receive a user-defined reward signal definition, receive a data input, utilize a decision-making model to generate the ML output based upon the data input, receive a reward signal based upon the reward signal definition and the ML output, and alter the decision-making model so as to receive a stronger reward signal for subsequently generated ML outputs. Other types of ML may also be employed, including deep or combined learning techniques.

The ML module 714 may include a set of computer-executable instructions implementing ML training (e.g., model creation, fine-tuning, retraining, etc.). The ML module 714 may access one or more repositories (e.g., the database 735) or any other data source for training data suitable to generate and/or otherwise train one or more ML models. The training data may be sample data with assigned relevant and comprehensive labels (classes or tags) used to fit the parameters (weights) of an ML model with the goal of training it by example. In one aspect, once an appropriate ML model is trained and validated to provide accurate predictions and/or responses, the trained model may be loaded into ML module 714 at runtime to process input data and generate output data.

The ML module 714 may receive labeled data at an input layer of a model having a networked layer architecture (e.g., an artificial neural network, a convolutional neural network, etc.) for training the one or more ML models. The received data may be propagated through one or more connected deep layers of the ML model to establish weights of one or more nodes, or neurons, of the respective layers. Initially, the weights may be initialized to random values, and one or more suitable activation functions may be chosen for the training process. The present techniques may include training a respective output layer of the one or more ML models. The output layer may be trained to output a prediction, for example.

The ML module 714 may include a set of computer-executable instructions implementing ML loading, configuration, initialization and/or operation functionality. The ML module 714 may include instructions for storing trained models (e.g., in the database 735). Once trained, the one or more trained ML models may be operated in inference mode, whereupon when provided with de novo input that the model has not previously been provided, the model may output one or more predictions, classifications, etc., as described herein.

While various implementations, examples, and/or aspects disclosed herein may include training and generating one or more ML models for the system 705 to load at runtime, it is also contemplated that one or more appropriately trained ML models may already exist (e.g., stored in the database 735, on the robot 740) such that the system 705 may load an existing trained ML model at runtime. It is further contemplated that the system 705 may retrain, fine-tune, update and/or otherwise alter an existing ML model before and/or after loading the model at runtime. Accordingly, one device (e.g., the system 705) of the computing environment 700 may train the ML model while another device (e.g., the robot 740) may execute the ML model.

The computing module 712 may include an input/output (I/O) module 716, including a set of computer-executable instructions implementing communication functions. The I/O module 716 may include a communication component configured to communicate (e.g., send and receive) data via one or more external/network port(s) to one or more components (e.g., the user interface 708), networks (e.g., the network 710) devices (e.g., the robot 740 and/or the computing device 760) as described herein. I/O module 716 may further include or implement an operator interface configured to present information to an administrator or operator and/or receive inputs from the administrator and/or operator (e.g., via the user interface 708). The I/O module 716 may facilitate I/O components (e.g., ports, capacitive or resistive touch sensitive input panels, keys, buttons, lights, LEDs), which may be directly accessible via, or attached to, the system 705 or may be indirectly accessible via or attached to another device (e.g., the computing device 760).

The memory 704 may include at least one machine learning (ML) model 718. The ML model 718 may include one or more routines, functions, algorithms, ML models, and/or other element(s) stored in memory 704. The ML model 718 may be referred to as receiving an input, producing or storing an output, or executing, the routine, model, or other element. The ML model 718 may be executing as instructions on the processor 702. Further, those of skill in the art will appreciate that the ML model 718 be stored in the memory 704 as executable instructions, which instructions the processor 702 may retrieve from the memory 704 and execute. Further, the processor 702 should be understood to retrieve from the memory 704 any data necessary to perform the executed instructions (e.g., data required as an input to ML model 718), and to store in the memory 704 the intermediate results and/or output of any executed instructions. The ML model 718 may include the RFM 718A and/or the language model 718B.

The memory 704 may include one or more subsystems 720. The subsystems 720 may configured to perform one or more functions associated with generating test environments (e.g., virtual, physical) to optimize performance of robots, as further described herein.

The memory 704 may store a testing application 730. The testing application 730 may cause an associated computing device (e.g., the system 705, the robot 740, the computing device 760) to perform one or more functions associated with associated with generating test environments, such as implementing one or more of the ML model 718, subsystems 720, causing one or more components and/or devices of the computing environment 700 (e.g., the system 705, the database 735, the robot 740, and/or computing device 760) to generate, analyze, obtain, store, and/or otherwise process data (e.g., operational data, virtual operational data, virtual sensor data, API data, virtual operational data, operational data, etc.), configuring and/or communicating with the devices and/or components of the computing environment 700 (e.g., via the network 710), and/or any other suitable function(s) associated with generating test environments to optimize performance of robots. In at least some implementations, the testing application 730 may include, and/or otherwise implement (e.g., remotely at another computing device via the network 710), a simulation platform 730A (e.g., the simulation platform 104). The simulation platform 730A may be and/or include a platform (e.g., software and/or hardware) configured to generate the virtual test environments (e.g., the virtual test environment 200) that mimic real-world scenarios in which the robot 740 operates, as previously described.

The network 710 may generally enable bidirectional communication between devices and/or components of the computing environment 700 (e.g., the system 705, the database 735, the robot 740, and/or the computing device 760). The network 710 may be, and/or include, one or more wired communication networks and/or a wireless communication networks. The wired communication network may include one or more Ethernet connections, Fiber Optics, Power Line Communications (PLCs), Serial Communications, Coaxial Cables, Quantum Communication, Advanced Fiber Optics, Hybrid Networks, and the like. The wireless communication network may include one or more of wireless fidelity (Wi-Fi), cellular networks (e.g., fourth generation (4G), fifth generation (5G), sixth generation (6G), Bluetooth®, ZigBee®, long-range wide area network (LoRaWAN), satellite communication, radio frequency identification (RFID), internet-of-things (IoT) networks, mesh networks, non-terrestrial networks (NTNs), near field communication (NFC), and the like. The network 710 may include any suitable network or networks, including a local area network (LAN), wide area network (WAN), Internet, and/or combination thereof. In one aspect, the network 710 may include a cellular base station, such as cellular tower(s), communicating to the one or more components of the computing environment 700 via wired/wireless communications based upon any one or more of various mobile phone standards, including Global System for Mobile Communications® (GSM), Code Division Multiple Access® (CDMA), Universal Mobile Telecommunications System® (UMTS), Long Term Evolution® (LTE), Ultra-wideband® (UWB), and/or the like. Additionally, or alternatively, the network 710 may include one or more routers, wireless switches, or other such wireless connection points communicating to the components of the computing environment 700 via wireless communications based upon any one or more of various wireless standards, including by non-limiting example, IEEE® 802.11 a/ac/ax/b/c/g/n (Wi-Fi), Bluetooth®, and/or the like.

The computing environment 700 may include the database 735. The database 735 may be a relational database, such as Oracle®, DB2®, MySQL®, a NoSQL® based database, such as MongoDB®, or another suitable database. The database 735 may store data and/or datasets include one or more types of data, records, files, etc., however, the terms “data” and “dataset” may be used interchangeably herein. In at least some implementations, the database 735 may store and/or manage data related to generating test environments to optimize performance of robots, such as storing relevant data, enabling efficient data retrieval, and enabling analysis to support decision-making processes associated with functionality for generating virtual test environments to optimize performance of the robot 740. For example, the database 735 may be configured to store model training data, the ML models 718, robot configuration data, robot operational data, and/or another suitable data. It should be understood that data stored in the database 735 may be stored in one or more other suitable storage components (e.g., one or more of the memories 704, 744, 764). One or more components and/or devices of the computing environment 700 (e.g., the system 705, robot 740, the computing device 760) may access the database 735 (e.g., using the testing application 730) via the network 710. The database 735 may manage user access controls, configuration settings, and system logs, and may provide a comprehensive solution for data management and a security within the computing environment 700.

The robot 740 may be configured to perform one or more tasks within an environment, such as performing a mission in a physical test environment. The robot 740 may be, or include, one or more off a quadruped, a wheeled robot, a biped, a drone, an unmanned arial vehicle (UAV), or an unmanned terrestrial vehicle (UTV), and/or any other suitable robot. The robot 740 may include a processor 742 (e.g., the processor 702) a memory 704 (e.g., the memory 704), a network interface 746 (e.g., the network interface 706), and/or a user interface 748 (e.g., the user interface 708). The memory 744 may include the RFM 718A (e.g., to control operation of the robot 740). The robot 740 may include one or more of the language model 718B, the subsystems 720, and/or the testing application 730, however, such components may be optional and may thus be indicated using dashed lines. The testing application 730 of the robot 740 may include the same, or similar, functionality as the testing application 730 of the system 705.

The robot 740 may include at least one sensor 750. The sensor 750 may include, but is not restricted to, one or more imaging sensors (e.g., camera, complementary metal-oxide-semiconductor (CMOS), light detection and ranging (LIDAR), radio detection and ranging (RADAR), infrared (IR)), chemical sensors (e.g., oxygen, carbon dioxide), pressure sensors, navigation sensors (e.g., global position system (GPS), inertial measurement unit (IMU)), gyroscopes, accelerometers), proprioceptive sensors, environmental sensors (e.g., humidity, temperature, wind, ultra-violet (UV)), and/or any other suitable sensor. The sensor 750 may capture sensor data that may indicate and/or otherwise be associated with sensing one or more characteristics of the physical environment of the robot 740 and/or the robot 740 itself.

The robot 740 may be configured to operate (e.g., navigate, perform tasks) autonomously without intervention (e.g., input, feedback, control, etc., from another device and/or user), semiautonomously with at least some intervention, and/or anything therebetween. For example, in implementations where the robot 740 may operate autonomously, the robot 740 may execute the testing application 730 to perform a mission by navigating through a physical test environment that requires the robot 740 to have an understating of its location, orientation, and/or pose within the environment and/or of the objects of the physical test environment proximate the robot 740. To perform the mission, the robot 740 may execute one or more of the ML models 718, the subsystems 720, the testing application 730, etc.

The computing environment 700 may include at least one computing device 760. The computing device 760 may include one or more user devices, mobile devices, smartphones, Personal Digital Assistants (PDAs), tablet computers, phablet computers, wearable computing devices, virtual reality (VR) devices, augmented reality (AR) devices, laptops, desktops, display interface panels, control panels, human machine interface panels, liquid crystal display (LCD) screens, light-emitting diode (LED) screens, and the like. The computing device 760 may include a processor 762 (e.g., the processor 702, 742) a memory 764 (e.g., the memory 704, 744), a network interface 766 (e.g., the network interface 706, 746), a user interface 768 (e.g., the user interface 708, 748). The memory 764 may include the testing application 730 including the same, or similar, functionality as the testing application 730 of the system 705 and/or robot 740. In at least some implementations, the testing application 730 may allow a user of the computing device 760 to provide input associated with generating virtual test environments to optimize performance of the robot 740. For example, the user may provide input associated with analyzing virtual operational data (e.g., whether operational characteristics meet test criteria), the configuration of a test environment, etc..

The computing environment 700 may include additional, fewer, and/or alternate components, and may be configured to perform additional, fewer, or alternate actions, including components/actions described herein. Although the computing environment 700 is shown in FIG. 7 as including one instance of various components such as the system 705, the database 735, the robot 740, and the computing device 760, various aspects include the computing environment 700 implementing any suitable number of any of the components shown in FIG. 7 and/or omitting any suitable ones of the components shown in FIG. 7. For example, model training data described as being stored in the database 735 may be stored in the memory 704 of the system 705 and therefore the database 735 may be omitted. Moreover, various aspects include the computing environment 700 including any suitable additional component(s) not shown in FIG. 7, such as but not limited to the exemplary components described above. Furthermore, it should be appreciated that additional and/or alternative connections between components shown in FIG. 7 may be implemented. As just one example, system 705 and the database 735 may be connected via a direct communication link (not shown in FIG. 7) instead of, or in addition to, via the network 710.

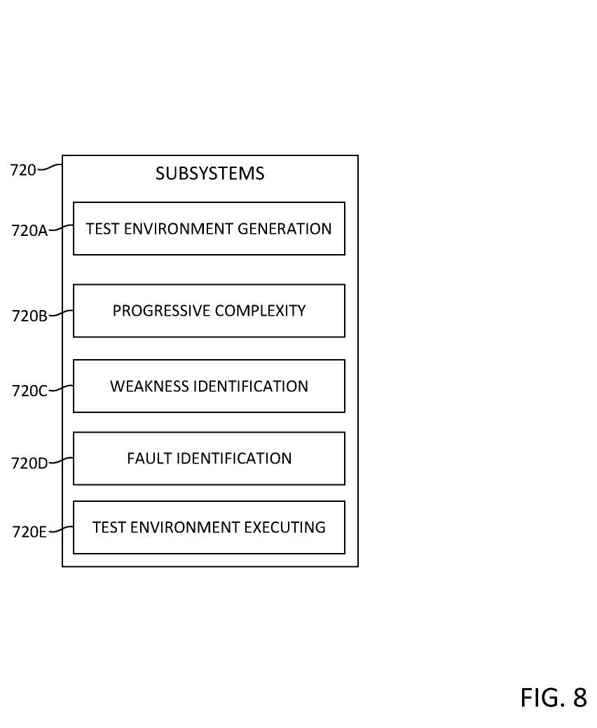

FIG. 8 is a block diagram depicting example subsystems 720 of the computing environment 700 of FIG. 7, in one implementation of the instant application. The test environment generation subsystem 720A may be configured to generate data (e.g., test environment data via the language model 718B) associated with generating test environments, such as generating realistic and varied virtual test environment via the simulation platform 730A and/or generating physical test environments via the robot 740 (e.g., the adversarial physical robot 506B).

The test environment generation subsystem 720A may implement and/or otherwise provide access to the API. The API may include a set of tools and/or protocols allowing different devices, components and/or application of the computing environment 700 (e.g., the language model 718B, the robot 740, the simulation platform 730A) to communicate, for example to dynamically create digital twins, configure the RFM 718A and/or robot 740, and/or generate the virtual test environment. The digital twins may include virtual replicas of physical, non-virtual environments (e.g., a virtual test environment simulating a physical test environment such as factories, warehouses, construction zones, etc.) and/or objects (e.g., a RFM 718A simulating the functionality of the physical robots 740. The virtual environment may simulate a physical environment where robots 740 may operate, ensuring testing conditions are as close to reality as possible.

The test environment generation subsystem 720A may randomly or procedurally change several characteristics of the virtual test environment, such as lighting conditions, object placement, addition or removal of obstacles, and the like. For instance, the test environment generation subsystem 720A may simulate situations such as low lighting in a warehouse, or cluttered floors in a factory, making sure that the RFM 718A and/or the robot 740 face realistic and unpredictable challenges during virtual mission and physical missions, respectively. Such an approach guarantees that the dynamic test environments are not repetitive and are varied enough to test the adaptability of the RFM 718A and/or the robot 740.

In an exemplary embodiment, the test environment generation subsystem 720A employs the language model 718B (e.g., a large language model) to automatically generate test environment data and/or the new and complex virtual test environments based thereupon. The language model 718B may be an advanced artificial intelligence model trained on vast amounts of data to understand and generate human-like text, but in the system 705, the language model 718B may be employed for more than text generation. The language model 718B may interact with the simulation platform 730A (e.g., via the API), allowing the language model 718B to control and design the diverse test environments. The language model 718B may employ its procedural generation capability to dynamically create scenarios that are tailored to the one or more robots (e.g., the RFM 718A, the robot 740) being tested, ensuring each test environment is unique. The procedural generation capability refers to algorithmic creation of the test environments, without manual input, allowing the language model 718B to come up with endless variations of testing situations. The test environment generation subsystem 720A may be configured to create the dynamic test environments that challenge the performance of one or more robots in new ways.

The language model 718B may continuously produce fresh scenarios that push the abilities of the robots to their limits, ensuring that the robots encounter a wide range of situations. For example, the language model 718B may be configured to simulate complex challenges that target various aspects of operational systems of a fleet of robots 740. The language model 718B may be configured to access a command API of the robot 740, thereby giving the language model 718B the flexibility to generate and execute intricate test cases (e.g., missions). With full control over the robot 740, the language model 718B may direct sophisticated stress tests and attacks that exploit both hardware and software vulnerabilities. The test environments may be non-repetitive and vary in scope, from low-level sensor interference to high-level coordination breakdowns or hacking attempts. The language model 718B may continuously evolve strategies based on the performance of the robots, using operational characteristics (e.g., obtained from the robot under test and/or the simulation platform and/or feedback from each test (e.g., via the performance analysis 108, 408) to fine-tune its future challenges. For example, the language model 718B may be configured to stress-test the robot fleet by exposing the robot fleet to a wide array of adversarial conditions, ranging from basic operational disruptions to advanced physical attacks. The language model 718B may push the robot fleet to its functional limits, identifying how well the robot fleet may cope with real-world environments or extreme cases, such as, but not constrained to, at least one of: environmental hazards, system overloads, security breaches, and the like.

A progressive complexity management subsystem 720B may be configured to adjust the difficulty of the test environments as the capabilities of robots improve. The progressive complexity management subsystem 720B may ensure that the complexity of the test scenarios and/or environments evolve with the performance of the robots, maintaining a constant challenge and preventing stagnation in the robot testing process. By tracking operational characteristics (e.g., virtual and non-virtual) of the robots and learning over time, the progressive complexity management subsystem 720B may assess how well the robots handle various tasks (e.g., missions) and obstacles. Based on this assessment, the progressive complexity management subsystem 720B may systematically increase the difficulty of the dynamic test environments, introducing new variables such as tighter spaces, more intricate tasks, faster-paced challenges, and the like.

A weakness identification subsystem 720C may be configured to expose the weaknesses (e.g., faults, operational limits, and/or otherwise weak points) of the RFM 718A and/or robot 740 by simulating challenging and adversarial scenarios. The weakness identification subsystem 720C may perform or otherwise implement red-teaming that refers to the practice of acting as an adversary to discover vulnerabilities and/or otherwise weaknesses of the robot under test. The weakness identification subsystem 720C may be configured to identify where the robot under test may struggle, for example as indicated by the associated (virtual) operational characteristics of the robot during the (virtual) mission. By focusing on targeted testing, the weakness identification subsystem 720C may ensure that each testing environment highlights a specific aspect of the performance of the robot, pushing the robot to handle unusual, unexpected, or extreme situations that may provide an indication (e.g., via the (virtual) operational characteristics) of how the robots behave under pressure and assists in identifying any performance gaps or shortcomings that may not be obvious under normal conditions. The insights gained from this process may enable necessary adjustments and improvement that optimize the performance of robots.

A fault identification subsystem 720D may be configured to determine patterns indicating where a robot may be configured with the faults. The faults may be issues with physical parts (such as sensors or navigation) of the robot 740, problems in software (such as bugs or security flaws) of the robot 740, and challenges with how the robot 740 communicates and works together with another robot 740. Such faults may be simulated by the RFM 718A having a corresponding configuration as the robot 740. The fault identification subsystem 720D may create a feedback loop by sending information associated with the faults to one or more users (e.g., of the system 705, the computing device 760), the language model 718B, and/or other suitable components of the computing environment 700. The feedback loop may be configured to assist the robot 740 improve its performance over time by learning from mistakes and enhancing performance in future test environments.

A test environment executing subsystem 720E may be configured to implement the test environments generated by the test environment generation subsystem 720A. The test environment executing subsystem 720E may be configured to actively execute the virtual test environments (e.g., at the simulation platform 730A), for example with adversarial robots (e.g., the adversarial physical robot 506B) which act as “challengers” against the robot under test. The adversarial robots may be tasked with various forms of attacks and challenges, such as physical disruptions (e.g., placing obstacles in the path of the robot 740 under test), operational interference (e.g., causing miscommunication or network outages), cybersecurity attacks (e.g., hacking or data tampering), and the like. This allows for a comprehensive evaluation of the robustness of the robot under test across a wide spectrum of potential real-world problems. By mimicking realistic threats, the test environment executing subsystem 720E may determine how the robot under test reacts to stress and adversarial actions in real-time conditions. The test environment executing subsystem 720E may be configured to operate in both virtual environments (e.g., simulated via the simulation platform 730A) and/or physical environment. The dual functionality enables the test environment executing subsystem 720E to test the RFM 718A and/or robot 740 in controlled, repeatable simulations, while also assessing performance in real-life conditions, ensuring the robot may handle unpredictable and dynamic environments. Furthermore, the test environment executing subsystem 720E may exhibit adaptive behavior, for example based on the information provided via the language model 718B. The adversarial robot may adjust its tactics mid-test to introduce greater complexity and explore newly discovered vulnerabilities in the robot under test.

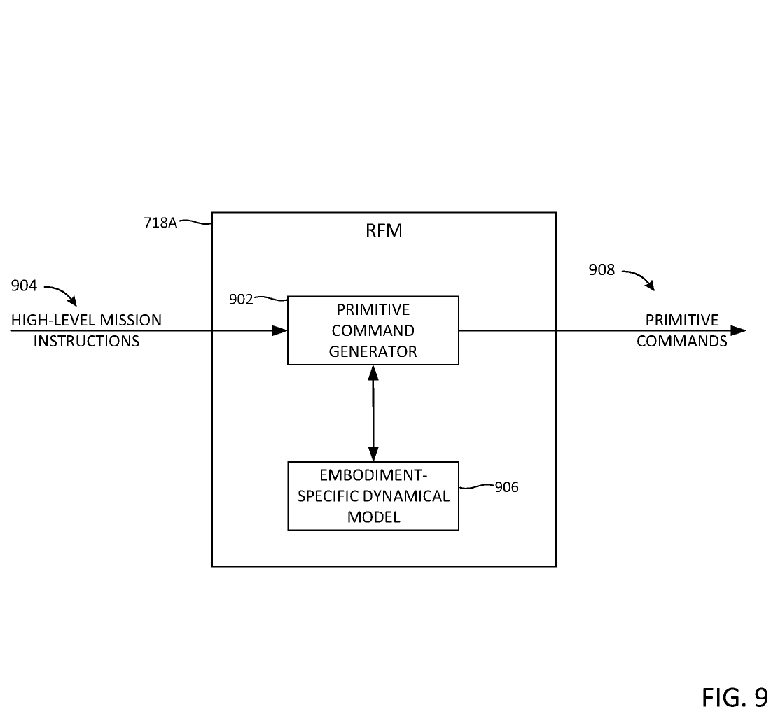

FIG. 9 is a block diagram of an example robotics foundation model (RFM) 718A of the computing environment 700 of FIG. 7, in one implementation of the instant application. The RFM 718A may include a primitive command generator 902 that receives high-level mission instructions 904 (e.g., received from the language model 718B as application programming interface (API) data) and/or other suitable source, device, and/or component. The high-level mission instructions 904 may include explicit risk-reward features associated with performing the mission. The primitive command generator 902 may provide the high-level mission instructions 904 as an input to the embodiment-specific dynamical model 906. The embodiment-specific dynamical model 906 may include a dynamical model that configured for the specific embodiment of the robot 740, such as a wheeled robot, a biped, a drone. The embodiment-specific dynamical model 906 may map the explicit risk-reward features to commands used to control the robot 740. The controller (e.g., the processor 702) of the robot 740 may expose an application programming interface (API) that enables the primitive command generator 902 to issue primitive commands 908 to the robot 740 to control the operation of the robot 740. The level of granularity of control over the robot 740 (e.g., actuable components of the robot 740) can vary depending upon the specific embodiment. For example, the actuable components may include motors, servos, or other such elements that can control various elements of the robot 740. These elements can be used to navigate through the environment and/or interact with the environment, such as a physical testing environment. The robot 740 may include the API that enables the primitive command generator 902 to provide the primitive commands 908 that have low level control over numerous aspects of the operation of the robot 740, while other robots 740 may provide an API that accepts higher level commands that are translated by the controller of the robot 740 into low level commands that are used to control the actuable components. Accordingly, the embodiment-specific dynamical model 906 may be configured to understand the specific API data receive via the API provided by the specific embodiment of the robot 740 to generate the correct primitive commands 908 for that API based on the high-level mission instructions. A technical benefit of this approach is that the API data may be agnostic to the specific embodiment of the robot 740, enabling the RFM 718A to be utilized with numerous different robot 740 by selecting an appropriate embodiment-specific dynamical model 906 for the robot 740.

While various embodiments and/or implementations have been described, the description is intended to be exemplary, rather than limiting, and it is understood that many more embodiments and/or implementations are possible that are within the scope of the embodiments and/or implementations. Although many possible combinations of features are shown in the accompanying figures and discussed in this detailed description, many other combinations of the disclosed features are possible. Any feature of any embodiment and/or implementation may be used in combination with or substituted for any other feature or element in any other embodiment and/or implementation unless specifically restricted. Therefore, it will be understood that any of the features shown and/or discussed in the present disclosure may be implemented together in any suitable combination. Accordingly, the embodiments and/or implementations are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

WHAT IS CLAIMED IS:

1. A system for generating virtual test environments to optimize performance of robots, the system comprising:
one or more processors; and
one or more memories having stored thereon processor-executable instructions that, when executed by the one or more processors, cause the one or more processors to perform operations of:
generating, at a simulation platform via a language model, a virtual test environment configured for testing performance of a robotics foundational model (RFM) during a virtual mission in the virtual test environment, wherein:
the virtual test environment simulates a physical environment; and
the RFM corresponds to a physical robot, and is configured to perform a virtual mission in the virtual test environment;
testing the performance of the RFM during the virtual mission in the virtual test environment including:
(a) causing the RFM to perform the virtual mission in the virtual test environment;
(b) obtaining virtual operational data associated with the performance of the virtual mission, the virtual operational data indicating one or more virtual operational characteristics of the RFM during the virtual mission, wherein the one or more virtual operational characteristics of the RFM correspond to one or more respective operational characteristics of the physical robot; and
(c) analyzing the virtual operational data to determine whether the virtual operational data indicates a virtual operational characteristic for further testing of the one or more virtual operational characteristics; and
based upon determining the virtual operational data indicates the virtual operational characteristic for further testing, providing the virtual operational data to the language model as an input causing the language model to reconfigure, at the simulation platform, the virtual test environment for testing the virtual operational characteristic of the RFM for further testing indicated in the virtual operational data, and repeating steps (a)-(c).

2. The system of claim 1, wherein the virtual test environment is configured to perform one or more of: simulate an atypical physical environment, test subpar performance of the RFM indicated by the virtual operational characteristic for further testing, test improved performance of the RFM associated with the virtual operational characteristic for further testing, test a policy under test of the RFM, test a model under test of the RFM, or test collaboration of multiple RFMs.

3. The system of claim 1, the one or more memories further comprising instructions for generating the virtual test environment at the simulation platform via the language model that, when executed by the one or more processors, cause the one or more processors to perform operations of:
determining, a virtual characteristic of the virtual test environment based upon one or more of: the RFM, the virtual mission, or the virtual operational characteristic for further testing;
generating application programming interface data associated with configuring the virtual test environment with the virtual characteristic; and
transmitting, via the language model, the application programming interface data to the simulation platform to configure the virtual test environment with the virtual characteristic.

4. The system of claim 3, the one or more memories further comprising instructions that, when executed by the one or more processors, cause the one or more processors to perform operations of:
identifying, from a plurality of fine-tuned language models, one or more fine-tuned language models for configuring the virtual characteristic of the virtual test environment; and
causing each of the one or more identified fine-tuned language models to generate a respective application programming interface dataset of the application programming interface data for configuring the respective virtual characteristic of the virtual test environment.

5. The system of claim 1, wherein the one or more virtual operational characteristics of the RFM during the virtual mission are associated with one or more of: an amount of time to complete the virtual mission, an information gain of the RFM during the virtual mission, collaboration between multiple RFMs during the virtual mission, a simulated hardware characteristics of the RFM, or a simulated software characteristics of the RFM.

6. The system of claim 1, the one or more memories further comprising instructions that, when executed by the one or more processors, cause the one or more processors to perform operations of:
receiving, from the simulation platform, virtual operational data indicating the one or more virtual operational characteristics of the RFM during the virtual mission;
analyzing the virtual operational data to determine whether the one or more virtual operational characteristics satisfy virtual testing criteria associated with the one or more virtual operational characteristics; and
identifying the virtual operational characteristic for further testing based upon determining the virtual operational characteristic for further testing does not satisfy the associated virtual testing criteria.

7. The system of claim 6, further comprising instructions that, when executed by the one or more processors, cause the one or more processors to perform operations of:
generating, via the simulation platform, virtual sensor data provided as an input to the RFM while performing the virtual mission, wherein the virtual sensor data is generated via one or more virtual sensors of the RFM by sensing the virtual test environment during the virtual mission; and
generating, via the RFM, the virtual operational data based upon receiving the virtual sensor data while performing the virtual mission.

8. The system of claim 1, wherein reconfiguring the virtual test environment for testing the virtual operational characteristic for further testing includes one or more of: reconfiguring a virtual environmental condition of the virtual test environment, reconfiguring a location of a virtual object in the virtual test environment, adding a virtual obstacle to the virtual test environment, or removing a virtual obstacle from the virtual test environment.

9. The system of claim 1, further comprising instructions that, when executed by the one or more processors, cause the one or more processors to perform operations of:
causing the physical robot to perform a mission in a physical test environment corresponding to the RFM performing the virtual mission in the virtual test environment;
obtaining operational data generated via the physical robot indicating one or more operational characteristics of the physical robot during the mission;
analyzing the operational data to determine whether the one or more operational characteristics satisfies a corresponding testing criteria;
identifying an operational characteristic for further testing of the one or more operational characteristics based upon determining the operational characteristic for further testing does not satisfy the corresponding testing criteria;
generating, based upon the operational characteristic identified for further testing, robot configuration data used for reconfiguring the physical robot to improve the operational characteristic during performance of the mission; and
reconfiguring the physical robot using the robot configuration data.

10. The system of claim 9, wherein the language model is configured to perform one or more of: cause the physical robot to perform the mission, generate the robot configuration data, or reconfigure the physical robot using the robot configuration data.

11. The system of claim 9, further comprising instructions that, when executed by the one or more processors, cause the one or more processors to perform operations of causing an adverse condition for the physical robot during performance of the mission, the adverse condition associated with one or more of: a hardware issue of the physical robot, a software issue of the physical robot, a physical interference of the physical robot.

12. The system of claim 11, wherein the adverse condition is caused by the language model communicating, via an application programming interface, with one or more of: the physical robot to cause the adverse condition or an adversarial physical robot causing the adverse condition.

13. The system of claim 1, the one or more memories further comprising instructions that, when executed by the one or more processors, cause the one or more processors to perform operations of:
generating, based upon the virtual operational data, updated training data for training the RFM to improve the one or more virtual operational characteristics of the RFM during the virtual mission; and
retraining the RFM using the updated training data to improve the one or more virtual operational characteristics of the RFM during the virtual mission.

14. A computer-implemented method for generating virtual test environments to optimize performance of robots, the computer-implemented method comprising:
generating, by one or more processors, at a simulation platform via a language model, a virtual test environment configured for testing performance of a robotics foundational model (RFM) during a virtual mission in the virtual test environment, wherein:
the virtual test environment simulates a physical environment; and
the RFM corresponds to a physical robot, and is configured to perform a virtual mission in the virtual test environment;
testing, via the one or more processors, the performance of the RFM during the virtual mission in the virtual test environment including:
(a) causing the RFM to perform the virtual mission in the virtual test environment;
(b) obtaining virtual operational data associated with the performance of the virtual mission, the virtual operational data indicating one or more virtual operational characteristics of the RFM during the virtual mission, wherein the one or more virtual operational characteristics of the RFM correspond to one or more respective operational characteristics of the physical robot; and
(c) analyzing the virtual operational data to determine whether the virtual operational data indicates a virtual operational characteristic for further testing of the one or more virtual operational characteristics; and
based upon analyzing the virtual operational data, performing, by the one or more processors, a testing action associated with providing the virtual operational data to the language model and repeating steps (a)-(c).

15. The computer-implemented method of claim 14, wherein:
analyzing the virtual operational data determines the virtual operational data indicates the virtual operational characteristic for further testing and performing the testing action includes:
providing, via the one or more processors, the virtual operational data to the language model as an input causing the language model to reconfigure, at the simulation platform, the virtual test environment for testing the virtual operational characteristic for further testing, and
repeating, via the one or more processors, steps (a)-(c); or
analyzing the virtual operational data determines the virtual operational data does not indicate the virtual operational characteristic for further testing and performing the testing action includes:
refraining, via the one or more processors, from providing the virtual operational data to the language model, and
refraining, via the one or more processors, from repeating steps (a)-(c).

16. The computer-implemented method of claim 14, wherein generating the virtual test environment at the simulation platform via the language model further comprises:
determining, via the one or more processors, a virtual characteristic of the virtual test environment based upon one or more of: the RFM, the virtual mission, or the virtual operational characteristic for further testing;
generating, via the one or more processors, application programming interface data associated with configuring the virtual test environment with the virtual characteristic; and
transmitting, via the one or more processors via the language model, the application programming interface data to the simulation platform to configure the virtual test environment with the virtual characteristic.

17. The computer-implemented method of claim 16, further comprising:
identifying, via the one or more processors from a plurality of fine-tuned language models, one or more fine-tuned language models for configuring the virtual characteristic of the virtual test environment; and
causing, via the one or more processors, each of the one or more identified fine-tuned language models to generate a respective application programming interface dataset of the application programming interface data for configuring the respective virtual characteristic of the virtual test environment.

18. The computer-implemented method of claim 14, further comprising:
receiving, via the one or more processors from the simulation platform, virtual operational data indicating the one or more virtual operational characteristics of the RFM during the virtual mission;
analyzing, via the one or more processors, the virtual operational data to determine whether the one or more virtual operational characteristics satisfy virtual testing criteria associated with the one or more virtual operational characteristics; and
identifying, via the one or more processors, the virtual operational characteristic for further testing based upon determining the virtual operational characteristic for further testing does not satisfy the associated virtual testing criteria.

19. The computer-implemented method of claim 14, further comprising:
causing, via the one or more processors, the physical robot to perform a mission in a physical test environment corresponding to the RFM performing the virtual mission in the virtual test environment;
obtaining, via the one or more processors, operational data generated via the physical robot indicating one or more operational characteristics of the physical robot during the mission;
analyzing, via the one or more processors, the operational data to determine whether the one or more operational characteristics satisfies a corresponding testing criteria;
identifying, via the one or more processors, an operational characteristic for further testing of the one or more operational characteristics based upon determining the operational characteristic for further testing does not satisfy the corresponding testing criteria;
generating, via the one or more processors based upon the operational characteristic identified for further testing, robot configuration data used for reconfiguring the physical robot to improve the operational characteristic during performance of the mission; and
reconfiguring, via the one or more processors, the physical robot using the robot configuration data.

20. A non-transitory computer-readable medium storing processor-executable instructions that, when executed by one or more processors, cause the one or more processors to:
generate, at a simulation platform via a language model, a virtual test environment configured for testing performance of a robotics foundational model (RFM) during a virtual mission in the virtual test environment, wherein:
the virtual test environment simulates a physical environment; and
the RFM corresponds to a physical robot, and is configured to perform a virtual mission in the virtual test environment;
test the performance of the RFM during the virtual mission in the virtual test environment including:
(a) cause the RFM to perform the virtual mission in the virtual test environment;
(b) obtain virtual operational data associated with the performance of the virtual mission, the virtual operational data indicating one or more virtual operational characteristics of the RFM during the virtual mission, wherein the one or more virtual operational characteristics of the RFM correspond to one or more respective operational characteristics of the physical robot; and
(c) analyze the virtual operational data to determine whether the virtual operational data indicates a virtual operational characteristic for further testing of the one or more virtual operational characteristics; and
based upon determining the virtual operational data indicates the virtual operational characteristic for further testing, provide the virtual operational data to the language model as an input causing the language model to reconfigure, at the simulation platform, the virtual test environment for testing the virtual operational characteristic of the RFM for further testing indicated in the virtual operational data, and repeating steps (a)-(c).
